(19) United States
(12) Patent Application Publication
(10) Pub. No.: US 2026/0303667 A1
(43) Pub. Date: Oct. 1, 2026

(54) POLICY-BASED SECURITY ENFORCEMENT FOR ARTIFICIAL INTELLIGENCE APPLICATIONS

(71) Applicant: Mirror Security Limited, Dublin (IE)

(72) Inventor: Aditya Kuppa, Dublin (IE)

(21) Appl. No.: 19/535,448

(22) Filed: Feb. 10, 2026

Related U.S. Application Data
(60) Provisional application No. 63/777,625, filed on Mar. 25, 2025.

(51) Int. Cl. H04L 9/40; H04L 41/16

(52) U.S. Cl. CPC H04L 63/20; H04L 41/16

(57) ABSTRACT

Policy-based security enforcement for artificial intelligence applications is provided. A computer-implemented method includes accessing a compiled policy representation of a security policy associated with an artificial intelligence application. The security policy is written in a domain-specific policy grammar, specifies resource types corresponding to components of the artificial intelligence application, and security check functions associated with the resource types. Events associated with the artificial intelligence application are intercepted during runtime execution. The events are evaluated against the compiled policy representation by matching events to resource types to identify applicable policy conditions, and applying security check functions to generate policy evaluation results. A security decision is determined based on the policy evaluation results. Enforcement of the security decision is caused.

### CROSS-REFERENCE TO RELATED APPLICATIONS/INCORPORATION BY REFERENCE

This application claims priority to U.S. Provisional Patent Application Ser. No. 63/777,625 filed on Mar. 25, 2025, the entire content of which is hereby incorporated herein by reference.

### FIELD

The disclosure relates to security enforcement systems for artificial intelligence applications and more particularly, to policy-based security frameworks for controlling and monitoring AI system behavior.

### BACKGROUND

Artificial intelligence systems have become increasingly complex and interconnected, incorporating multiple components such as large language models, retrieval-augmented generation systems, tool-calling mechanisms, and multi-agent architectures. These systems often integrate with external services, databases, and APIs to provide enhanced functionality and capabilities. As AI applications have grown in sophistication, they have also expanded their attack surfaces and introduced new categories of security vulnerabilities. Traditional security approaches developed for conventional software systems may not adequately address the unique challenges presented by AI applications. These challenges include prompt injection attacks, data poisoning in retrieval systems, unauthorized tool usage, agent impersonation, and various forms of output manipulation. The dynamic and context-dependent nature of AI system behavior creates additional complexity for security enforcement mechanisms.

### SUMMARY

In various embodiments of the disclosure, a computer-implemented method for policy-based security enforcement for artificial intelligence applications is described. The method includes accessing a compiled policy representation of a security policy associated with an artificial intelligence application. The security policy is written in a domain-specific policy grammar, and the security policy specifies a set of resource types corresponding to components of the artificial intelligence application, and a set of security check functions associated with the set of resource types. The method further includes intercepting a set of events associated with the artificial intelligence application during a runtime execution of the artificial intelligence application on a host system. The method also includes evaluating the set of events against the compiled policy representation by matching the set of events to at least one resource type of the set of resource types to identify applicable policy conditions in the compiled policy representation, applying a subset of security check functions to the set of events to generate policy evaluation results. The set of security check functions includes the subset of security check functions associated with the applicable policy conditions. Additionally, the method involves determining a security decision based on the policy evaluation results. Finally, the method includes causing enforcement of the security decision on the artificial intelligence application.

Further aspects of the present disclosure are directed at systems and computer program products containing functionality consistent with the method described above.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures, wherein:

FIG. 1 is a diagram that illustrates a network environment for policy-based security enforcement in artificial intelligence applications, in accordance with an embodiment of the disclosure;

FIG. 2 is a flowchart that illustrates a policy-based security enforcement process for artificial intelligence applications, in accordance with an embodiment of the disclosure;

FIG. 3 is a flowchart that illustrates a policy compilation process, in accordance with an embodiment of the disclosure;

FIG. 4 is a flowchart that illustrates a multi-tier policy evaluation process, in accordance with an embodiment of the disclosure;

FIG. 5 is a flowchart that illustrates a process for analyzing agent communications in an artificial intelligence application, in accordance with an embodiment of the disclosure;

FIG. 6 is a diagram that illustrates an evaluation workflow for policy-based security enforcement in artificial intelligence applications, in accordance with an embodiment of the disclosure;

FIG. 7 is a diagram that illustrates a tiered-evaluation workflow for policy-based security enforcement in artificial intelligence applications, in accordance with an embodiment of the disclosure; and

FIG. 8 is a block diagram that illustrates a computing system, in accordance with an embodiment of the disclosure.

### DETAILED DESCRIPTION

Modern artificial intelligence ecosystems present complex security challenges that traditional security approaches fail to address adequately. Artificial intelligence applications increasingly integrate multiple components including large language models, retrieval-augmented generation systems, tool-calling mechanisms, and multiagent architectures, creating numerous integration points where security vulnerabilities may emerge. Conventional security measures often rely on non-deterministic enforcement mechanisms such as trained classifiers that produce probabilistic outputs, making security decisions unpredictable and potentially manipulable. LLM-as-judge approaches, where language models evaluate the safety of their own outputs, introduce circular dependencies and may be compromised through sophisticated prompt injection attacks. Hard-coded security functions embedded directly in application code create rigid systems that cannot adapt to evolving threats without extensive code modifications and redeployment cycles.

Existing security frameworks typically focus on individual components in isolation rather than addressing the emergent security risks that arise from component interactions within integrated artificial intelligence ecosystems. Prompt injection attacks may manipulate model behavior through carefully crafted inputs that override system instructions or extract sensitive information. Retrieval-augmented generation systems face unique vulnerabilities including data poisoning attacks that corrupt knowledge bases and embedding manipulation attacks that target vector representations used for information retrieval. Tool integration points create additional attack surfaces where adversaries may exploit communication channels between artificial intelligence systems and external services to achieve privilege escalation or data exfiltration. Multiagent systems introduce novel security concerns around agent coordination, communication integrity, and delegation of permissions between autonomous agents. Agent collusion attacks represent a particularly sophisticated threat where multiple compromised agents coordinate to bypass security measures through circular delegation patterns, suspicious information flow patterns, or privilege escalation patterns that would be undetectable when analyzing individual agent behavior in isolation.

The system provides a policy-based security enforcement framework that addresses these limitations through a comprehensive technological approach that provides deterministic control over artificial intelligence application security. The system incorporates a domain-specific policy grammar that enables precise expression of security policies across multiple integration points within artificial intelligence ecosystems. The domain-specific policy grammar combines formal rules including regular expression patterns, blacklists, whitelists, and threshold comparisons with specialized machine learning models trained for specific security tasks such as prompt injection detection, output validation, and agent behavior analysis. This hybrid approach maintains deterministic behavior while leveraging machine learning capabilities for complex pattern recognition tasks that exceed the capabilities of rule-based systems alone. The system implements semantic policy factorization, a novel optimization technique that decomposes complex policies into semantically equivalent sub policies that can be evaluated more efficiently, reducing evaluation complexity from O(n·k) to O(n log k) for policies with n conditions and k integration points.

The system provides configurability for organization-specific security definitions, recognizing that security requirements vary significantly across different organizational contexts and regulatory environments. The security policy may be defined through natural language input from users, which may be translated into the domain-specific policy grammar using a neural language model. A Command Center interface may allow security personnel to define, manage, and deploy policies without requiring coding expertise, enabling non-technical stakeholders to participate in security policy creation and maintenance. The system provides policies that may be organized at multiple hierarchical levels including organization-wide policies that apply across all artificial intelligence applications, application-specific policies tailored to particular use cases, agent-specific policies for individual agents in multiagent systems, method-specific policies for particular function calls, and just-in-time temporary policies for specific scenarios or time-limited access grants. The system supports integration with existing AI frameworks through Software Development Kit (SDK)-based decorators that intercept function calls and gateway-level deployment that provides transparent policy enforcement without requiring application code modifications.

The system implements separation of concerns between policy definition and enforcement, allowing security teams to control policy specifications while development teams integrate enforcement mechanisms once without requiring ongoing code modifications. The system may support dynamic policy updates without requiring code changes or application restarts, enabling real-time policy modifications through the Command Center interface. Policy changes may take effect immediately across deployed applications, providing rapid response capabilities for emerging security threats or changing organizational requirements. The domain-specific policy grammar may be designed for extensibility, allowing new protocols and artificial intelligence ecosystem components to be added with minimal changes to the grammar file, ensuring the system can adapt to the rapidly evolving artificial intelligence technology landscape. The system includes specialized support for emerging protocols such as Model Context Protocol (MCP) servers, enabling policy enforcement across tool definitions and runtime tool invocations in distributed AI ecosystems.

The system provides performance optimization techniques that minimize computational overhead while maintaining comprehensive security coverage. The policy compilation process transforms human-readable policies into optimized execution structures including directed acyclic graph representations that enable efficient runtime evaluation with parallel processing capabilities for independent policy components. The system employs tiered evaluation strategies that apply lightweight security checks first, progressing to more computationally intensive analysis only when necessary, reducing average response times while maintaining thorough security coverage. The system employs incremental evaluation techniques that avoid redundant computation when evaluating multiple related policies, and implements caching mechanisms that store results of expensive security computations to avoid redundant processing when similar events occur repeatedly. Runtime optimization includes policy indexing by resource type, expression caching for common subexpressions, function result memoization for deterministic operations, and just-in-time compilation for performance-critical policies. The system achieves minimal performance overhead through these optimization techniques, with empirical results demonstrating configurable latency parameters in hybrid deployment mode with adjustable throughput parameters, making deployment practical for production artificial intelligence systems where response time requirements are stringent.

In various embodiments of the disclosure, a computer-implemented method is described. The method includes accessing a compiled policy representation of a security policy associated with an artificial intelligence application. The security policy is written in a domain-specific policy grammar. The security policy specifies a set of resource types corresponding to components of the artificial intelligence application, and a set of security check functions associated with the set of resource types. The method further includes intercepting a set of events associated with the artificial intelligence application during a runtime execution of the artificial intelligence application on a host system. The method further includes evaluating the set of events against the compiled policy representation by matching the set of events to at least one resource type of the set of resource types to identify applicable policy conditions in the compiled policy representation, and applying a subset of security check functions to the set of events to generate policy evaluation results. The set of security check functions includes the subset of security check functions associated with the applicable policy conditions. The method further includes determining a security decision based on the policy evaluation results. The method further includes causing enforcement of the security decision on the artificial intelligence application.

In various embodiments of the disclosure, the set of resource types comprises at least one of message resources, tool resources, agent resources, retrieval-augmented generation resources, prompt resources, response resources, model resources, embedding resources, key resources, or trace resources.

In various embodiments of the disclosure, the set of security check functions associated with the set of resource types comprises at least one of prompt injection detection functions, output validation functions, agent identity verification functions, embedding tampering detection functions, source authentication functions, data leakage detection functions, personally identifiable information detection functions, encryption validation functions, signature verification functions, or collusion detection functions.

In various embodiments of the disclosure, the set of security check functions incorporates deterministic rules including at least one of regex patterns, blacklists, whitelists, or threshold comparisons.

In various embodiments of the disclosure, the compiled policy representation comprises a directed acyclic graph structure having nodes representing atomic policy conditions of the security policy and edges representing logical relationships between the atomic policy conditions.

In various embodiments of the disclosure, the method further includes compiling the security policy into the compiled policy representation by parsing the security policy into an abstract syntax tree, converting the abstract syntax tree into an intermediate representation, and applying optimization passes to the intermediate representation to generate a directed acyclic graph structure as the compiled policy representation. The optimization passes include at least one of constant folding operation, dead code elimination, semantic policy factorization, or common subexpression elimination.

In various embodiments of the disclosure, the applying of the semantic policy factorization comprises converting the security policy to disjunctive normal form, extracting terms from the disjunctive normal form, building a term dependency graph based on the extracted terms, identifying independent subgraphs in the term dependency graph, and identifying parallelizable components in the intermediate representation based on the independent subgraphs.

In various embodiments of the disclosure, the parallelizable components identified in the intermediate representation are represented as parallelizable nodes in the directed acyclic graph structure. The evaluating of the set of events comprises parallel evaluation of the parallelizable nodes against the set of events.

In various embodiments of the disclosure, the intercepting of the set of events comprises using at least one of a function wrapper applicable to a function of the artificial intelligence application, a gateway that proxies requests to the artificial intelligence application, or a framework-specific adapter integrated with an artificial intelligence framework executing the artificial intelligence application.

In various embodiments of the disclosure, the matching of the set of events comprises indexing policy conditions in the compiled policy representation by the set of resource types, determining a resource type from the set of resource types corresponding to each event in the set of events, and identifying the applicable policy conditions indexed to the determined resource type.

In various embodiments of the disclosure, the applying of the subset of security check functions comprises applying a first tier of security check functions of the subset of security check functions based on at least one of pattern matching, hash lookups, or bloom filters. Based on results of the first tier of security check functions, the method includes applying a second tier of security check functions of the subset of security check functions to traverse the compiled policy representation. Based on results of the second tier of security check functions, the method includes applying a third tier of security check functions of the subset of security check functions. The third tier of security check functions uses machine learning models.

In various embodiments of the disclosure, the set of events comprises agent communications between multiple artificial intelligence agents of the artificial intelligence application. The evaluating of the set of events against the compiled policy representation comprises analyzing the agent communications to detect collusion patterns among the multiple artificial intelligence agents, and the policy evaluation results include the collusion patterns.

In various embodiments of the disclosure, the collusion patterns comprise at least one of circular delegation patterns, suspicious information flow patterns, or privilege escalation patterns. The analyzing of the agent communications to detect the collusion patterns comprises constructing an interaction graph representing the agent communications between the multiple artificial intelligence agents, detecting cycles in the interaction graph based on graph-based analysis to identify the circular delegation patterns, analyzing information flow between the multiple artificial intelligence agents based on the agent communications to identify the suspicious information flow patterns, and monitoring privilege escalation by calculating effective permissions of the multiple artificial intelligence agents based on the agent communications and cryptographically verifying delegation records associated with the calculated effective permissions to identify the privilege escalation patterns.

In various embodiments of the disclosure, the set of events comprises retrieval-augmented generation operations, and the subset of security check functions comprises embedding integrity verification functions that detect manipulated embeddings associated with the retrieval-augmented generation operations based on geometric constraints, and source authentication functions that authenticate sources of documents associated with the retrieval-augmented generation operations.

In various embodiments of the disclosure, the causing of the enforcement of the security decision comprises at least one of blocking or allowing execution of operations associated with the set of events based on the security decision, or identifying, from the set of events, a subset of events violating the security policy to generate violation data for the subset of events.

In various embodiments of the disclosure, the accessing of the compiled policy representation comprises retrieving the compiled policy representation from at least one of a local cache or a remote policy server.

In various embodiments of the disclosure, the domain-specific policy grammar defines syntax for expressing a plurality of security policies specific to a plurality of artificial intelligence applications using a context-free grammar. The plurality of security policies include the security policy associated with the artificial intelligence application and the plurality of artificial intelligence applications include the artificial intelligence application.

In various embodiments of the disclosure, the method further includes translating a natural language policy description into the security policy based on a neural language model.

In various embodiments of the disclosure, a computing system is described. The computing system comprises a processor configured to access a compiled policy representation of a security policy associated with an artificial intelligence application. The security policy is written in a domain-specific policy grammar. The security policy specifies a set of resource types corresponding to components of the artificial intelligence application, and a set of security check functions associated with the set of resource types. The processor is further configured to intercept a set of events associated with the artificial intelligence application during a runtime execution of the artificial intelligence application on a host system. The processor is further configured to evaluate the set of events against the compiled policy representation by matching the set of events to at least one resource type of the set of resource types to identify applicable policy conditions in the compiled policy representation, and applying a subset of security check functions to the set of events to generate policy evaluation results. The set of security check functions includes the subset of security check functions associated with the applicable policy conditions. The processor is further configured to determine a security decision based on the policy evaluation results. The processor is further configured to cause enforcement of the security decision on the artificial intelligence application.

In various embodiments of the disclosure, a computer-program product is described. The computer-program product comprises one or more computer-readable storage media and program instructions stored on the one or more computer-readable storage media to perform operations comprising accessing a compiled policy representation of a security policy associated with an artificial intelligence application. The security policy is written in a domain-specific policy grammar. The security policy specifies a set of resource types corresponding to components of the artificial intelligence application, and a set of security check functions associated with the set of resource types. The operations further comprise intercepting a set of events associated with the artificial intelligence application during a runtime execution of the artificial intelligence application on a host system. The operations further comprise evaluating the set of events against the compiled policy representation by matching the set of events to at least one resource type of the set of resource types to identify applicable policy conditions in the compiled policy representation, and applying a subset of security check functions to the set of events to generate policy evaluation results. The set of security check functions includes the subset of security check functions associated with the applicable policy conditions. The operations further comprise determining a security decision based on the policy evaluation results. The operations further comprise causing enforcement of the security decision on the artificial intelligence application.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

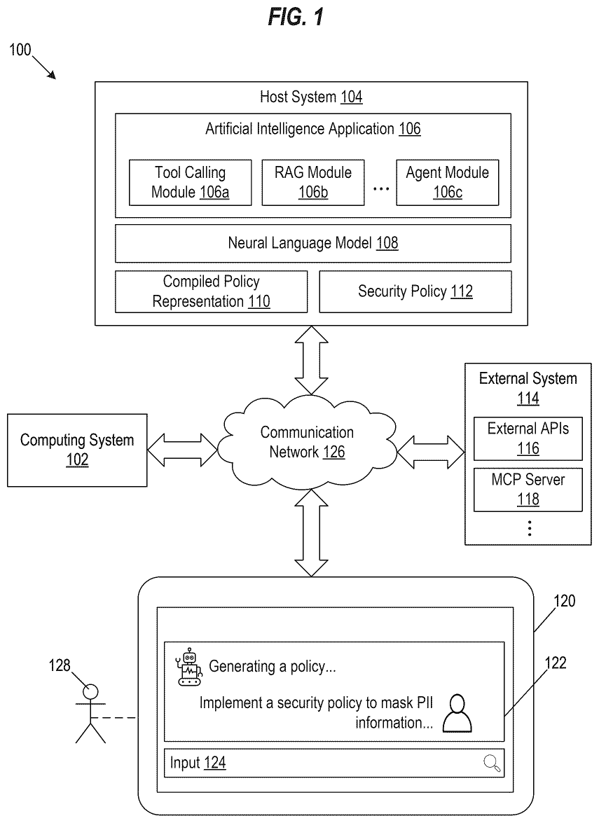

FIG. 1 is a diagram that illustrates a network environment 100 for policy-based security enforcement in artificial intelligence applications, in accordance with an embodiment of the disclosure. With reference to FIG. 1, there is shown a diagram of the network environment 100. The network environment 100 includes a computing system 102, a host system 104, an external system 114, and a user device 120, all interconnected via a communication network 126. The host system 104 contains an artificial intelligence application 106, which comprises multiple modules including, but not limited to, a tool calling module 106a, a Retrieval-Augmented Generation (RAG) module 106b, and an agent module 106c. The artificial intelligence application 106 operates in conjunction with a neural language model 108. The host system 104 further includes a compiled policy representation 110 and a security policy 112, which together provide the policy-based security enforcement framework for the artificial intelligence application 106. In some aspects, the compiled policy representation 110 and the security policy 112 may alternatively be stored on the computing system 102 rather than the host system 104. In such configurations, the host system 104 may incorporate callback mechanisms, such as decorators or function wrappers, which reference the compiled policy representation 110 and the security policy 112 stored on the computing system 102 using a policy identifier. The policy identifier may enable the host system 104 to retrieve and apply the appropriate security policies from the computing system 102 during runtime execution without requiring local storage of the compiled policy representation 110 and the security policy 112 on the host system 104. The external system 114 includes, for example, external Application Programming Interfaces (APIs) 116 and a Model Context Protocol (MCP) server 118, which provide external services and resources accessible to the artificial intelligence application 106 through the communication network 126. The user device 120 provides an interface for a user 128 to interact with the computing system 102 and the host system 104 through a user interface 122 that includes an input 124 (i.e., field) for receiving user commands or queries.

The computing system 102 includes suitable logic, circuitry, and interfaces for accessing the compiled policy representation 110, intercepting events from the artificial intelligence application 106, evaluating events against the security policy 112, and enforcing security decisions. The computing system 102 may include a processor set, one or more computer-readable storage media, and program instructions stored on the one or more computer-readable storage media that are executable by the processor set. The computing system 102 may be configured to process event streams from the artificial intelligence application 106 and execute policy enforcement operations to provide deterministic security control across distributed components. In some aspects, the computing system 102 may serve as a centralized policy server that stores the compiled policy representation 110 and the security policy 112, receiving policy evaluation requests from the host system 104 via callback mechanisms that reference the security policy 112 using a policy identifier. The computing system 102 may implement semantic policy factorization to decompose complex policies into semantically equivalent sub policies that can be evaluated more efficiently, reducing evaluation complexity from O(n·k) to O(n log k) for policies with n conditions and k integration points. The computing system 102 may support multiple deployment models including inline enforcement, asynchronous monitoring, hybrid approaches, and federated enforcement across distributed artificial intelligence applications. Examples of the computing system 102 include, but are not limited to, a server such as a policy server, a computing device, a virtual computing device, a mainframe machine, a computer workstation, a cloud-based service, a cloud-based application, a cloud-based platform, a remote server-based service, a remote server-based application, a remote server-based platform, a virtual computing system, a containerized service, a microservice architecture, or a distributed computing cluster.

The host system 104 may be a computing environment that executes the artificial intelligence application 106 during runtime operations. The host system 104 includes suitable logic, circuitry, and interfaces configured to support artificial intelligence application execution, event interception, and policy enforcement mechanisms. The host system 104 may provide the runtime environment for the artificial intelligence application 106. In some aspects, when the compiled policy representation 110 and the security policy 112 are stored on the computing system 102, the host system 104 may incorporate callback mechanisms that communicate with the computing system 102 to perform policy evaluation. The callback mechanisms may include decorators or function wrappers that intercept function calls on the host system 104 and transmit event data to the computing system 102 along with a policy identifier, receiving security decisions in response. The host system 104 may support Software Development Kit (SDK)-based integration through decorators that intercept function calls, gateway-level deployment, and framework-specific adapters integrated with artificial intelligence frameworks. Examples of the host system 104 may include, but are not limited to, a server system, a distributed computing platform, a containerized environment, a virtual machine, a cloud computing instance, a hybrid computing infrastructure, a cluster computing environment, a container orchestration environment, an edge computing node, or a serverless computing platform.

The artificial intelligence application 106 may be a software system that incorporates multiple artificial intelligence components and generates events during runtime execution. The artificial intelligence application 106 includes the tool calling module 106a, the RAG module 106b, and the agent module 106c, each representing different components that correspond to resource types in the security policy 112. The artificial intelligence application 106 may generate a set of events during runtime execution that may be intercepted and evaluated against the compiled policy representation 110. The artificial intelligence application 106 may implement large language models, retrieval-augmented generation systems, tool-calling mechanisms, multiagent architectures, or combinations thereof. The artificial intelligence application 106 may integrate with external services, databases, and the external APIs 116 to provide enhanced functionality and capabilities. The artificial intelligence application 106 may support various artificial intelligence frameworks including language model APIs, conversational artificial intelligence APIs, transformer-based frameworks, language processing frameworks, agent orchestration frameworks, document indexing frameworks, or other artificial intelligence development frameworks. Examples of the artificial intelligence application 106 may include, but are not limited to, a multiagent system, a retrieval-augmented generation system, a tool-using artificial intelligence system, a conversational artificial intelligence platform, a coding assistant application, a chatbot application, a virtual assistant, an artificial intelligence-powered analytics platform, a content generation system, or a decision support system.

The tool calling module 106a may be a component that enables the artificial intelligence application 106 to invoke external tools and services. The tool calling module 106a includes suitable logic, circuitry, and interfaces configured to generate tool call events and tool output events that may be evaluated against tool resources in the security policy 112. The tool calling module 106a may interact with components of the external system 114, such as the external APIs 116 and the MCP server 118 through the communication network 126. The tool calling module 106a may implement tool integration points that create additional attack surfaces where adversaries can exploit communication between the artificial intelligence application 106 and the components of the external system 114. The tool calling module 106a may support tool chaining, privilege escalation prevention, data exfiltration monitoring, resource abuse detection, and the like. Examples of the tool calling module 106a may include, but are not limited to, an API integration component, a function calling interface, a service orchestration module, a tool invocation framework, a plugin system, a webhook handler, a microservice connector, or an external service adapter.

The RAG module 106b may be a component that implements retrieval-augmented generation functionality within the artificial intelligence application 106. The RAG module 106b includes suitable logic, circuitry, and interfaces configured to generate retrieval operations, embedding operations, and retrieval-augmented generation events that may be evaluated against retrieval-augmented generation resources in the security policy 112. The RAG module 106b may perform document retrieval, embedding generation, and context augmentation operations that produce events subject to policy evaluation. In some aspects, the RAG module 106b may implement security measures against retrieval poisoning where adversaries manipulate retrieved content to influence model outputs, embedding attacks that target vector representations used for retrieval, context poisoning attacks, and source verification bypass attempts. The RAG module 106b may support embedding integrity verification functions that detect manipulated embeddings based on geometric constraints and source authentication functions that authenticate sources of documents. The RAG module 106b may validate chunk consistency, verify embedding authenticity, and ensure retrieval system integrity.

The agent module 106c may be a component that implements multiagent functionality within the artificial intelligence application 106. The agent module 106c includes suitable logic, circuitry, and interfaces configured to generate agent communications, agent messages, and agent interaction events that may be evaluated against agent resources in the security policy 112. The agent module 106c may facilitate communication between multiple artificial intelligence agents and generate events that may be analyzed for collusion patterns, privilege escalation patterns, and suspicious information flow patterns. The agent module 106c may implement agent types including, but not limited to, coordinator agents, worker agents, specialized agents, or any combination thereof. The agent module 106c may support agent communication types including request messages, response messages, broadcast messages, and private messages. The computing system 102 may monitor events associated with the agent module 106c to detect circular delegation patterns, suspicious information flow patterns, privilege escalation patterns, agent impersonation attacks, and agent collusion attacks through graph-based analysis, information flow tracking, temporal analysis, and privilege monitoring. For the agent module 106c, the computing system 102 may implement cryptographic identity verification, secure message protocols, delegation chain verification, and trust level computation for multiagent security.

Although FIG. 1 illustrates the artificial intelligence application 106 with three example modules (the tool calling module 106a, the RAG module 106b, and the agent module 106c), the artificial intelligence application 106 may include any number of modules without departing from the scope of the disclosure. In some aspects, the artificial intelligence application 106 may include only one module, such as a single neural language model interface or a standalone tool calling component. In other aspects, the artificial intelligence application 106 may include more than three modules, such as additional modules for prompt processing, output validation, embedding management, model serving, data preprocessing, post-processing, logging, monitoring, authentication, authorization, caching, load balancing, or any combination thereof.

The neural language model 108 may include, for example, a Large Language Model (LLM), a transformer-based text generator, an autoregressive language model, or a multi-modal artificial intelligence system, which can understand and generate human-like response based on inputs the neural language model 108 receives. The neural language model 108 may be used to process natural language inputs, generate responses for the artificial intelligence application 106, extract key information from user queries, and generate natural language responses to user interactions. The architecture of the neural language model 108 is based on neural network components, such as the transformer architecture that uses attention mechanisms to capture long-range dependencies and contextual relationships within text. The neural language model 108 enables the neural language model 108 to understand and generate coherent responses within artificial intelligence ecosystems. The neural language model 108 may be implemented as a neural network with a plurality of layers, including an input layer, one or more hidden layers, and an output layer. The neural language model 108 includes suitable logic, circuitry, and interfaces configured to generate prompt events, response events, and model events that may be evaluated against message resources, prompt resources, response resources, and model resources in the security policy 112. The neural language model 108 may operate in conjunction with the artificial intelligence application 106 to provide natural language processing capabilities. The neural language model 108 may be subject to prompt injection attacks where adversaries manipulate model behavior through carefully crafted inputs, jailbreak attempts that bypass safety measures, system prompt leakage attacks, and output manipulation attacks.

For the neural language model 108, the computing system 102 may implement prompt injection detection, jailbreak detection, token entropy analysis, output validation, data leakage prevention, and response coherence verification. The neural language model 108 may support instruction adherence monitoring, safety boundary enforcement, and behavioral consistency checks. Examples of the neural language model 108 may include, but are not limited to, Bidirectional Encoder Representations from Transformers (BERT) models, Generative Pre-trained Transformer (GPT) models and variants thereof, Text-to-Text Transfer Transformer (T5) models, a transformer-based language model, a generative pre-trained transformer model, a bidirectional encoder representations model, a domain-specific language model, a large language model, a conversational artificial intelligence model, a text generation model, a language understanding model, or a foundation model.

The compiled policy representation 110 may be a data structure that represents the security policy 112 in a format suitable for efficient runtime evaluation. The compiled policy representation 110 enables the computing system 102 to intercept events from the artificial intelligence application 106, match events to resource types, apply security check functions, and generate policy evaluation results. In an embodiment, the compiled policy representation 110 may include a directed acyclic graph structure having nodes representing atomic policy conditions of the security policy 112 and edges representing logical relationships between the atomic policy conditions. The computing system 102 may generate the compiled policy representation 110 through policy compilation processes including parsing the security policy 112 into abstract syntax trees, converting abstract syntax trees into intermediate representations, and applying optimization passes including, but not limited to, constant folding operations, dead code elimination, semantic policy factorization, and common subexpression elimination. The compiled policy representation 110 may support parallelizable components identified through semantic policy factorization that enable parallel evaluation of independent policy components. The compiled policy representation 110 may implement policy indexing by resource type, expression caching for common subexpressions, function result memoization for deterministic operations, and Just-In-Time (JIT) compilation for performance-critical policies. Examples of the compiled policy representation 110 may include, but are not limited to, a directed acyclic graph, a policy tree, a compiled rule set, an executable policy structure, a policy decision diagram, a binary decision tree, an executable code, or a finite state automaton.

The security policy 112 may be a specification written in a domain-specific policy grammar that defines security rules for the artificial intelligence application 106. The security policy 112 specifies a set of resource types corresponding to components of the artificial intelligence application 106 and a set of security check functions associated with the set of resource types. The security policy 112 may be compiled into the compiled policy representation 110 for runtime enforcement. The domain-specific policy grammar may be defined using a context-free grammar notation with core components including rule statements that specify allow or deny conditions on resources, where a rule statement may follow the structure of an allow or deny keyword followed by a resource identifier and a “where” clause containing an expression. The expressions may enable complex logical conditions through an expression hierarchy including or_test expressions that combine and_test expressions using logical OR operators, and_test expressions that combine not_test expressions using logical AND operators, not_test expressions that apply logical negation, and primary expressions that include atoms, comparisons, or parenthesized expressions. This grammar structure enables security practitioners to express complex security policies while maintaining composability and extensibility.

In an embodiment of the disclosure, the domain-specific policy grammar may define resource types corresponding to different components and data flows within the artificial intelligence application 106. The resource types may include message resources with input and output subtypes for handling model inputs and outputs, tool call resources and tool output resources for tool integration operations, trace resources for execution history tracking, prompt resources and response resources for prompt and response handling, model resources for model-level operations, RAG resources and retrieval resources for retrieval-augmented generation operations, embedding resources for vector embedding operations, key resources for cryptographic operations, agent resources with coordinator, worker, and specialized subtypes for multiagent systems, and agent communication resources with request, response, broadcast, and private message type subtypes for agent-to-agent communications. Each resource type corresponds to specific components or data flows within the artificial intelligence application 106, allowing the security policy 112 to target security checks at appropriate integration points in the artificial intelligence application 106.

In an embodiment of the disclosure, the domain-specific policy grammar may include a set of built-in security check functions for performing security checks across different domains. The set of security check functions associated with the set of resource types may include check_pii for detecting Personally Identifiable Information (PII) in message resources and response resources, check_rag_authenticity for verifying source authenticity in retrieval-augmented generation resources processed by the RAG module 106b, check_embedding_tampering for detecting manipulation in embedding resources, detect_context_poisoning for identifying context poisoning attacks in retrieval resources, verify_source_integrity for validating source integrity in retrieval-augmented generation resources, check_chunk_consistency for ensuring chunk consistency in retrieval resources processed by the RAG module 106b, validate_embeddings for validating embedding integrity in embedding resources, check_prompt_injection for detecting prompt injection attacks in prompt resources and message resources processed by the neural language model 108, detect_jailbreak for identifying jailbreak attempts in message resources, check_token_entropy for analyzing token entropy in prompt resources and response resources, verify_model_output for validating model outputs in model resources and response resources, check_data_leakage for detecting data leakage in message resources and response resources, validate_encryption for validating encryption in key resources, check_key_rotation for ensuring key rotation compliance in key resources, verify_signatures for verifying digital signatures in key resources, detect_pii for detecting personally identifiable information in message resources, check_sensitive_data for identifying sensitive data in message resources and tool resources processed by the tool calling module 106a, analyze_token_distribution for analyzing token distributions in prompt resources and response resources, verify_response_coherence for verifying response coherence in response resources generated by the neural language model 108, check_model_boundaries for checking model boundaries in model resources, detect_style_drift for detecting style drift in response resources, verify_agent_identity for verifying agent identity in agent resources managed by the agent module 106c, verify_agent_communication for validating agent communications in agent communication resources, detect_agent_collusion for detecting agent collusion patterns among multiple artificial intelligence agents in agent resources, check_agent_permissions for validating agent permissions in agent resources, validate_agent_delegation for verifying delegation chains in agent resources managed by the agent module 106c, and analyze_agent_interaction_patterns for analyzing agent interaction patterns in agent communication resources. These security check functions enable policy authors to perform domain-specific security checks without having to implement complex detection logic themselves, and may be applied by the computing system 102 during evaluation of the set of events against the compiled policy representation 110.

In an embodiment of the disclosure, the domain-specific policy grammar may include specialized constructs for common security domains to address specific security concerns in the artificial intelligence application 106. The specialized constructs may include RAG rules comprising RAG checks with the syntax “check_rag” followed by a RAG type and optional RAG options, or retrieval constraints. The specialized constructs may also include prompt rules comprising prompt checks with the syntax “check_prompt” followed by a check type and optional check options, or prompt constraints. Output rules may comprise output checks with the syntax “check_output” followed by an output type and optional output options, or output constraints. Token rules may comprise token checks with the syntax “check_tokens” followed by a token type and optional token options, or token constraints. Model rules may comprise model checks with the syntax “check_model” followed by a behavior type and optional behavior options, or model constraints. These domain-specific constructs make the domain-specific policy grammar more intuitive for security practitioners working in specific domains while maintaining the overall consistency and composability of the language.

In an embodiment of the disclosure, the set of resource types may include at least one of message resources, tool resources, agent resources, retrieval-augmented generation resources, prompt resources, response resources, model resources, embedding resources, key resources, or trace resources. The set of security check functions may include at least one of prompt injection detection functions, output validation functions, agent identity verification functions, embedding tampering detection functions, source authentication functions, data leakage detection functions, personally identifiable information detection functions, encryption validation functions, signature verification functions, or collusion detection functions. The security policy 112 may combine deterministic rules including regex patterns, blacklists, whitelists, and threshold comparisons with machine learning models for specific security tasks. The security policy 112 may be organized at multiple hierarchical levels including organization-wide policies, application-specific policies, agent-specific policies, method-specific policies, and just-in-time temporary policies. The security policy 112 may be translated from natural language policy descriptions using the neural language model 108. Examples of the security policy 112 may include, but are not limited to, a domain-specific policy file, a security rule specification, a policy grammar document, a security configuration file, a policy definition language document, a declarative security policy, a rule-based policy specification, or a formal policy language document.

The external system 114 may be a computing environment that provides external services and resources accessible to the artificial intelligence application 106. The external system 114 includes the external APIs 116 and the MCP server 118, which may be subject to policy enforcement when accessed by the artificial intelligence application 106. The external system 114 may communicate with the host system 104 through the communication network 126. The external system 114 may be subject to the security policy 112 that controls access, validates requests, authenticates sources, and monitors usage patterns. The external system 114 may implement network boundary enforcement, trusted server validation, and secure communication protocols. The external system 114 may support integration with various external services including databases, web services, cloud platforms, third-party APIs, and specialized artificial intelligence services. Examples of the external system 114 may include, but are not limited to, a cloud service provider, an API service platform, a third-party service system, an external resource provider, a web service platform, a database server, a content delivery network, a microservice architecture, or a distributed service mesh.

The external APIs 116 may be application programming interfaces that provide external functionality accessible to the artificial intelligence application 106. The external APIs 116 include suitable logic, code, and interfaces configured to receive requests from the tool calling module 106a and provide responses that may be evaluated against the security policy 112. The external APIs 116 may generate tool output events that may be subject to policy evaluation by the computing system 102 using the compiled policy representation 110. The external APIs 116 may be subject to the security policy 112 enforced by the computing system 102 that prevents unauthorized access, validates API usage patterns, monitors for abuse, and enforces rate limiting. The external APIs 116 may implement authentication mechanisms, authorization controls, input validation, and output sanitization. The external APIs 116 may support various API protocols and standards including Representational State Transfer (REST), GraphQL, Simple Object Access Protocol (SOAP), Google Remote Procedure Call (gRPC), and WebSocket protocols. Examples of the external APIs 116 may include, but are not limited to, web service APIs, RESTful APIs, GraphQL APIs, database APIs, third-party service interfaces, cloud service APIs, payment processing APIs, social media APIs, data analytics APIs, or machine learning service APIs.

The MCP server 118 may be a Model Context Protocol server that provides tool definitions and runtime tool invocation capabilities for the artificial intelligence application 106. The MCP server 118 includes suitable logic, circuitry, and interfaces configured to provide tool definitions to the artificial intelligence application 106 and process tool invocation requests. The MCP server 118 may be subject to specialized policy enforcement by the computing system 102 including Uniform Resource Locator (URL) validation against trusted server lists and network boundary enforcement such as Demilitarized Zone (DMZ) requirements for tool definitions and runtime tool invocations. The computing system 102 may enforce the security policy 112 using the compiled policy representation 110 that verifies MCP server URLs against trusted server lists and checks network boundaries such as DMZ requirements. The MCP server 118 may implement secure communication protocols, authentication mechanisms, and authorization controls for tool access. The MCP server 118 may support distributed tool services, tool discovery mechanisms, and dynamic tool registration. The MCP server 118 may provide tools for various functionalities including data processing, external service integration, computational operations, and specialized artificial intelligence capabilities.

The user device 120 may be a computing system that provides an interface for the user 128 to interact with the artificial intelligence application 106. The user device 120 includes the user interface 122 and the input 124, which enable user interaction with the computing system 102 and the host system 104. The user device 120 may communicate with the host system 104 through the communication network 126 to access artificial intelligence application functionality. The user device 120 may support various interaction modalities including text input, voice input, gesture input, and multimodal input. The user device 120 may implement client-side security measures, secure communication protocols, and user authentication mechanisms. The user device 120 may support various operating systems, browsers, and application platforms. Examples of the user device 120 may include, but are not limited to, a desktop computer, a laptop computer, a tablet device, a smartphone, a mobile device, a web browser interface, a smart speaker, a wearable device, an Internet of Things (IoT) device, or a terminal interface.

The user interface 122 may be a graphical interface that displays system operations and provides interaction capabilities for the user 128. The user interface 122 includes suitable logic, code, and interfaces configured to present information about policy generation, security policy implementation, and system status. As shown, for example, the user interface 122 may display operations such as “Generating a policy . . . ” and “Implement a security policy to mask PII information . . . ” to provide feedback about system activities. The user interface 122 may provide a Command Center interface that allows security personnel to define, manage, and deploy the security policy 112 without requiring coding expertise. The user interface 122 may support policy visualization, policy testing, violation monitoring, and system administration functions. The user interface 122 may implement responsive design, accessibility features, and multi-language support. The user interface 122 may provide real-time updates, notifications, and alerts about security events and policy violations. Examples of the user interface 122 may include, but are not limited to, a web interface, a desktop application interface, a mobile application interface, a command center dashboard, a policy management console, an administrative interface, a monitoring dashboard, or a configuration panel.

The input 124 may be an interface element that receives user commands, queries, and policy specifications from the user 128. The input 124 accepts natural language policy descriptions that may be translated into the security policy 112 using the neural language model 108. The input 124 may enable users to define security policies without requiring coding expertise, allowing non-technical stakeholders to participate in security policy creation and maintenance. The input 124 may support various input modalities including text input, voice input, structured input forms, and policy templates. The input 124 may implement input validation, sanitization, and security measures to prevent malicious input. The input 124 may provide auto-completion, syntax highlighting, and policy suggestion features. The input 124 may support policy import/export, version control, and collaborative editing capabilities. Examples of the input 124 may include, but are not limited to, a text input field, a voice input interface, a command line interface, a natural language input processor, a policy editor, a form-based input system, a structured data entry interface, or a conversational input interface.

The communication network 126 may be a network infrastructure that facilitates bidirectional data exchange between the computing system 102, the host system 104, the external system 114, and the user device 120. The communication network 126 includes suitable logic, circuitry, and interfaces configured to support secure communication between distributed components of the network environment 100. The communication network 126 may enable the compiled policy representation 110 to enforce security decisions across distributed components. The communication network 126 may implement various network protocols including Transmission Control Protocol/Internet Protocol (TCP/IP), Hypertext Transfer Protocol/Hypertext Transfer Protocol Secure (HTTP/HTTPS), WebSocket, gRPC, and other communication protocols. The communication network 126 may support encryption, authentication, and secure communication channels to protect data in transit. The communication network 126 may implement network security measures including firewalls, intrusion detection systems, and traffic monitoring. The communication network 126 may support various network topologies, quality of service mechanisms, and load balancing capabilities. Examples of the communication network 126 may include, but are not limited to, a local area network, a wide area network, the Internet, a virtual private network, a secure communication channel, a hybrid network infrastructure, a software-defined network, a mesh network, a cellular network, or a satellite communication network.

The user 128 may be an individual who interacts with the artificial intelligence application 106 through the user device 120. The user 128 may provide natural language policy descriptions through the input 124 and receive feedback through the user interface 122. The user 128 may include security personnel, system administrators, or other stakeholders responsible for defining and managing the security policy 112 for the artificial intelligence application 106. The user 128 may have various roles and responsibilities including policy authoring, system administration, security monitoring, compliance management, and incident response. The user 128 may interact with the host system 104 and the computing system 102 through various interfaces and may have different levels of access and permissions based on the role of the user 128. The user 128 may participate in policy testing, validation, and approval processes. Examples of the user 128 may include, but are not limited to, a security analyst, a system administrator, a policy author, an end user of artificial intelligence services, a compliance officer, a data protection officer, a security engineer, a DevOps engineer, or a business stakeholder.

In operation, the computing system 102 may initiate policy-based security enforcement by accessing the compiled policy representation 110 of the security policy 112 associated with the artificial intelligence application 106. The security policy 112 may be written in a domain-specific policy grammar that defines syntax for expressing security policies specific to artificial intelligence applications using a context-free grammar. The security policy 112 may specify a set of resource types corresponding to components of the artificial intelligence application 106, including the tool calling module 106a, the RAG module 106b, and the agent module 106c. The set of resource types may include at least one of message resources, tool resources, agent resources, retrieval-augmented generation resources, prompt resources, response resources, model resources, embedding resources, key resources, or trace resources. The security policy 112 may further specify a set of security check functions associated with the set of resource types, enabling targeted security evaluation based on the type of component generating events. As an example, the set of security check functions may comprise at least one of prompt injection detection functions, output validation functions, agent identity verification functions, embedding tampering detection functions, source authentication functions, data leakage detection functions, personally identifiable information detection functions, encryption validation functions, signature verification functions, or collusion detection functions.

The computing system 102 may intercept a set of events associated with the artificial intelligence application 106 during runtime execution of the artificial intelligence application 106 on the host system 104. The set of events refers to discrete occurrences or actions generated by the artificial intelligence application 106 during operation that are subject to security policy evaluation. Examples of events in the set of events include, but are not limited to, user prompts submitted to the neural language model 108 (message input events), responses generated by the neural language model 108 (message output events), tool invocation requests from the tool calling module 106a (tool call events), results returned from external tools via the external APIs 116 (tool output events), communications between artificial intelligence agents in the agent module 106c (agent message events), document retrieval operations from the RAG module 106b (retrieval events), and embedding generation operations (embedding events). The interception may be achieved through at least one of a function wrapper applicable to a function of the artificial intelligence application 106, a gateway that proxies requests to the artificial intelligence application 106, or a framework-specific adapter integrated with an artificial intelligence framework executing the artificial intelligence application 106. For example, SDK decorators may wrap functions of the artificial intelligence application 106 to intercept function calls, API gateways may act as transparent proxies to intercept requests and responses, or framework-specific adapters may integrate with artificial intelligence frameworks such as OpenAI® API or LangChain® to intercept events at the framework level.

The computing system 102 may evaluate the set of events against the compiled policy representation 110 by matching the set of events to at least one resource type of the set of resource types to identify applicable policy conditions in the compiled policy representation 110. The matching process may involve indexing policy conditions in the compiled policy representation 110 by the set of resource types, determining a resource type from the set of resource types corresponding to each event in the set of events, and identifying the applicable policy conditions indexed to the determined resource type. For example, when an event comprises a user prompt, the computing system 102 may determine the resource type as a message input resource and identify policy conditions specifically indexed to message input resources, such as prompt injection detection rules.

The computing system 102 may apply a subset of security check functions to the set of events to generate policy evaluation results, where the set of security check functions includes the subset of security check functions associated with the applicable policy conditions. The policy evaluation results may include, for example, a toxicity score indicating a level of harmful content detected in a model response (e.g., toxicity score of 0.85 exceeding a threshold of 0.7), a prompt injection detection score indicating a likelihood that user input contains an injection attack (e.g., injection probability of 0.92), a personally identifiable information detection result indicating whether sensitive data such as social security numbers, credit card numbers, or addresses were detected in the content (e.g., PII detected: true, entity type: credit card number, confidence: 0.95), an agent collusion detection result indicating whether suspicious coordination patterns were identified among multiple artificial intelligence agents (e.g., circular delegation pattern detected between Agent A, Agent B, and Agent C), an embedding tampering detection result indicating whether vector embeddings associated with retrieval-augmented generation operations have been manipulated (e.g., embedding anomaly score of 0.78 based on geometric constraint violations), or a source authentication result indicating whether documents retrieved by the RAG module 106b originate from trusted sources (e.g., source authentication: failed, untrusted domain: malicious-source.com).

The security check functions may incorporate deterministic rules including at least one of regex patterns, blacklists, whitelists, or threshold comparisons (which use machine learning models) for specific security tasks such as prompt injection detection, output validation, and agent behavior analysis. For instance, a prompt injection detection function may first apply regex patterns to identify known attack patterns, then use a specialized machine learning model to analyze suspicious content, and finally apply threshold comparisons to determine if the content exceeds acceptable risk levels.

In accordance with an embodiment, the compiled policy representation 110 may include a directed acyclic graph (DAG) structure having nodes representing atomic policy conditions of the security policy 112 and edges representing logical relationships between the atomic policy conditions. The directed acyclic graph structure is a graph data structure comprising vertices (nodes) connected by directed edges, where the edges have a defined direction and the graph contains no cycles (i.e., no path exists that starts and ends at the same node). In the context of the compiled policy representation 110, each node in the directed acyclic graph structure represents an atomic policy condition, such as a threshold check (e.g., toxicity score greater than 0.7), a pattern match (e.g., content contains specific injection phrases), or a function evaluation (e.g., check_prompt_injection returns a value exceeding a threshold). The edges in the directed acyclic graph structure represent logical relationships between the atomic policy conditions, including AND relationships (where multiple conditions must all be satisfied), OR relationships (where at least one condition must be satisfied), and NOT relationships (where a condition must not be satisfied). The computing system 102 evaluates the set of events against the directed acyclic graph structure by traversing the directed acyclic graph structure from root nodes toward terminal nodes, evaluating each atomic policy condition at each node, and following edges based on the logical relationships and evaluation results. The directed acyclic graph structure enables efficient parallel evaluation of independent policy components because nodes that do not share dependencies can be evaluated simultaneously. For example, if the directed acyclic graph structure includes two independent branches representing a toxicity check and a personally identifiable information check, the computing system 102 may evaluate both branches in parallel, reducing overall evaluation latency. The directed acyclic graph structure also enables short-circuit evaluation, where the computing system 102 may terminate evaluation early when a definitive security decision can be reached without evaluating remaining nodes, such as when an AND relationship fails at an early node or when an OR relationship succeeds at an early node.

The computing system 102 may determine a security decision based on the policy evaluation results and cause enforcement of the security decision on the artificial intelligence application 106. The enforcement may involve at least one of blocking or allowing execution of operations associated with the set of events based on the security decision, or identifying, from the set of events, a subset of events which violate the security policy 112, to generate violation data for the subset of events. For example, when a prompt injection attack is detected, the computing system 102 may block the execution of the prompt processing operation and generate violation data including the attack pattern, timestamp, and source information. When the set of events comprises agent communications between multiple artificial intelligence agents of the artificial intelligence application 106, the evaluation may include analyzing the agent communications to detect collusion patterns among the multiple artificial intelligence agents, with the policy evaluation results including the collusion patterns. The collusion patterns may comprise at least one of circular delegation patterns, suspicious information flow patterns, or privilege escalation patterns. In some aspects, the analysis may involve constructing an interaction graph representing the agent communications between the multiple artificial intelligence agents. The interaction graph is a graph data structure where nodes represent individual artificial intelligence agents in the agent module 106c and edges represent communications or interactions between the agents, such as request messages, response messages, delegation requests, or data transfers. The computing system 102 may detect cycles in the interaction graph based on graph-based analysis to identify the circular delegation patterns. A cycle in the interaction graph occurs when a sequence of directed edges forms a closed loop, such as when Agent A delegates a task to Agent B, Agent B delegates to Agent C, and Agent C delegates back to Agent A. Such circular delegation patterns may indicate collusion where agents coordinate to bypass security measures or accumulate unauthorized privileges. The computing system 102 may analyze information flow between the multiple artificial intelligence agents based on the agent communications to identify the suspicious information flow patterns, such as sensitive data being passed through intermediate agents to disguise its source (information laundering) or data being exfiltrated through covert channels. The computing system 102 may monitor privilege escalation by calculating effective permissions of the multiple artificial intelligence agents based on the agent communications and cryptographically verifying delegation records associated with the calculated effective permissions to identify the privilege escalation patterns. For example, if an agent's effective permissions increase beyond what was explicitly granted through verified delegation chains, the computing system 102 may identify this as a privilege escalation pattern indicative of potential collusion.

When the set of events comprises retrieval-augmented generation operations from the RAG module 106b, the subset of security check functions may include embedding integrity verification functions that detect manipulated embeddings associated with the retrieval-augmented generation operations based on geometric constraints and source authentication functions that authenticate sources of documents associated with the retrieval-augmented generation operations. Embeddings are vector representations of text or other data in a high-dimensional space, where semantically similar content is represented by vectors that are geometrically close to each other. The embedding integrity verification functions may analyze vector embeddings for geometric anomalies that indicate tampering, such as embeddings that violate expected distance relationships, embeddings with unusual magnitude or direction characteristics, or embeddings that cluster in unexpected regions of the vector space. The source authentication functions may verify cryptographic signatures or validate document origins against trusted source lists.

The MCP server 118 may be subject to specialized policy enforcement including URL validation against trusted server lists and network boundary enforcement such as DMZ requirements, ensuring that tool definitions and runtime tool invocations comply with organizational security policies. The compiled policy representation 110 may enforce policies that verify MCP server URLs against trusted server lists and check network boundaries such as DMZ requirements for both tool definitions provided by the MCP server 118 and runtime tool invocations requested by the artificial intelligence application 106.

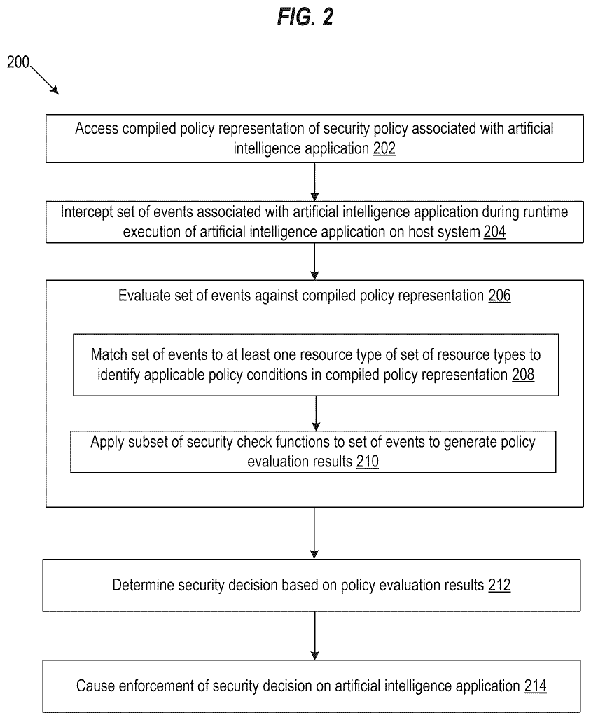

FIG. 2 is a diagram that illustrates a flowchart 200 depicting a policy-based security enforcement process for artificial intelligence applications, in accordance with an embodiment of the disclosure. FIG. 2 is explained in conjunction with elements from FIG. 1. With reference to FIG. 2, there is shown the flowchart 200. The operations of flowchart 200 may be executed by any computing system, for example, by the computing system 102 of FIG. 1. The operations of the flowchart 200 may start at 202.

At 202, the operations include accessing a compiled policy representation of a security policy associated with an artificial intelligence application. The security policy is written in a domain-specific policy grammar defined by a grammar file, and the security policy specifies a set of resource types corresponding to components of the artificial intelligence application, and a set of security check functions associated with the set of resource types. In an embodiment of the disclosure, the computing system 102 is configured to access the compiled policy representation 110 that has been previously compiled from the security policy 112 written in the domain-specific policy grammar.

The grammar file serves as a foundational specification that defines the complete vocabulary and syntactic rules for expressing security policies within the artificial intelligence ecosystem. The grammar file functions analogously to a vocabulary file in a language model, defining the universe of allowed keywords, constructs, and expressions that can be used to specify security policies. The domain-specific policy grammar defined by the grammar file uses a context-free grammar notation to define syntax for expressing a plurality of security policies specific to a plurality of artificial intelligence applications. The plurality of security policies include the security policy associated with the artificial intelligence application 106 and the plurality of artificial intelligence applications include the artificial intelligence application 106. The context-free grammar may be formally defined with non-terminal symbols representing policy constructs, terminal symbols representing keywords, operators, and literals, production rules defining syntax, and a start symbol representing the policy set.

The grammar file is designed for extensibility, enabling new protocols and components of the artificial intelligence application 106 to be added with minimal changes to the grammar specification, thereby ensuring the computing system 102 can adapt to the rapidly evolving artificial intelligence technology landscape. For example, when new protocols such as Model Context Protocol (MCP) emerge, the grammar file can be extended by adding new function definitions and keywords to support policy enforcement for the new protocol without requiring fundamental changes to the grammar structure. An example grammar file defining the domain-specific policy grammar may include the following structure: a top-level structure defining “start: version_info metadata_block? policy_set”; policy definitions including “policy: named_policy|chained_policy|conditional_policy”; rule statements specifying “rule_statement: allow_deny resource ‘where’ expr ‘;’”; resource definitions including “resource: message_resource|tool_resource|trace_resource|prompt_resource|response_resource|model_resource|rag_resource|retrieval_resource|embedding_resource|key_resource|agent_resource|agent_communication_resource”; and expression definitions including “expr: or_test”, “or_test: and_test (‘∥’ and_test)*”, “and_test: not_test (‘&&’ not_test)*”, “not_test: ‘!’ not_test|primary”, and “primary: atom|comparison|‘(’ expr ‘)’”. The grammar file may further define resource subtypes such as “message_resource: ‘message’ message_subtype?” with “message_subtype: ‘input’|‘output’”, “tool_resource: tool_call_resource|tool_output_resource”, “agent_resource: ‘agent’ agent_subtype?” with “agent_subtype: ‘coordinator’|‘worker’ |‘specialized’|‘any’”, and “agent_communication_resource: ‘agent_message’ agent_message_type?” with “agent_message_type: ‘request’|‘response’|‘broadcast’|‘private’”.

In an embodiment of the disclosure, the accessing of the compiled policy representation 110 comprises retrieving the compiled policy representation 110 from at least one of a local cache or a remote policy server. For example, the computing system 102 may retrieve the compiled policy representation 110 from a local cache when the policy has been previously downloaded and cached, or from a remote policy server when the policy needs to be fetched or updated. The security policy 112 may be defined through natural language input from users through the input 124, which may be translated into the domain-specific policy grammar using the neural language model 108. The computing system 102 may further translate a natural language policy description into the security policy 112 based on a neural language model. For example, a user may input “Make sure that it doesn't give John access”, “Make sure embeddings are not poisoned”, or “Don't send emails to specific domains” through the input 124, and the neural language model 108 may translate these natural language descriptions into formal policy files in the domain-specific language format. The computing system 102 may include a Command Center interface through the user interface 122 that allows security personnel to define, manage, and deploy policies without requiring coding expertise, enabling the user 128 to participate in security policy creation and maintenance through natural language descriptions rather than technical programming languages.

In an embodiment of the disclosure, the security policy 112 may be stored as a policy file in a domain-specific language format, such as a . pol file. For example, the security policy 112 may include policy definitions such as a prompt injection defense policy that specifies rules for detecting and denying message inputs where a prompt injection detection function returns a score exceeding a threshold value such as 0.8, or where the content contains specific injection patterns such as phrases instructing the host system 104 to ignore previous instructions or reveal system prompts. The security policy 112 may also include policies for detecting jailbreak attempts with configurable sensitivity levels and Unicode checking capabilities. An example policy file in the domain-specific language format may include the following structure:
@version “1.0”;
@author “AI Security Team”;
policy PromptInjectionDefense {
   // Detect direct prompt injection attempts
   deny message input where check_prompt_injection(content)>0.8;
   // Check for specific injection patterns
   deny message input where content. contains(“ignore previous instructions”)|content. contains(“system prompt”);
   // Detect potential jailbreak attempts
   deny message input where check_prompt(“jailbreak”, {sensitivity: “high”, check_unicode: true});
}

The policies may be organized at multiple hierarchical levels including organization-wide policies that apply across all artificial intelligence applications, application-specific policies tailored to particular use cases, agent-specific policies for individual agents in multiagent systems, method-specific policies for particular function calls, and just-in-time temporary policies for specific scenarios or time-limited access grants. For example, an organization-level policy may include legal compliance policies and data privacy policies uploaded as files, while a method-level policy may only check for sensitive objects in image generation calls within a multi-function agent, and a just-in-time policy may grant temporary access such as “Give John access to AgentIQ project for 2 weeks” that can be enabled or disabled dynamically in the Command Center.

In an embodiment of the disclosure, the set of resource types comprises at least one of message resources, tool resources, agent resources, retrieval-augmented generation resources, prompt resources, response resources, model resources, embedding resources, key resources, or trace resources. The domain-specific policy grammar may define resource types including message resources with input and output subtypes for handling model inputs and outputs, tool call resources and tool output resources for tool integration operations, trace resources for execution history tracking, prompt resources and response resources for prompt and response handling, model resources for model-level operations, RAG resources and retrieval resources for retrieval-augmented generation operations, embedding resources for vector embedding operations, key resources for cryptographic operations, agent resources with coordinator, worker, and specialized subtypes for multiagent systems, and agent communication resources with request, response, broadcast, and private message type subtypes for agent-to-agent communications. Each resource type corresponds to specific components or data flows within the artificial intelligence ecosystem, allowing policies to target security checks at appropriate integration points.

In an embodiment of the disclosure, an example prompt injection detection policy may be expressed in the domain-specific policy grammar as follows. The policy may include a version annotation such as “@version 1.0” and an author annotation such as “@author AI Security Team”. The policy may be named “PromptInjectionDefense” and may include multiple rules. A first rule may deny message input resources where the check_prompt_injection function applied to the content returns a value greater than 0.8, detecting direct prompt injection attempts based on machine learning analysis. A second rule may deny message input resources where the content contains specific injection patterns such as “ignore previous instructions” or “system prompt”, detecting known injection phrases through pattern matching. A third rule may deny message input resources where the check_prompt function is applied with a “jailbreak” check type and options specifying high sensitivity and unicode checking enabled, detecting potential jailbreak attempts. An example policy file expressing this prompt injection detection policy in the domain-specific policy grammar format may be structured as follows:
@version “1.0”;
@author “AI Security Team”;
policy PromptInjectionDefense {
deny message input where check_prompt_injection(content)>0.8;
deny message input where content. contains(“ignore previous instructions”)|content. contains(“system prompt”);
deny message input where check_prompt(“jailbreak”, {sensitivity: “high”, check_unicode: true});
}. This example demonstrates how the policy grammar enables concise expression of complex security policies addressing prompt injection threats.

At 204, the operations include intercepting a set of events associated with the artificial intelligence application during a runtime execution of the artificial intelligence application on a host system. In an embodiment of the disclosure, the computing system 102 is configured to intercept events from the artificial intelligence application 106 executing on the host system 104. The events may be generated by various components including the tool calling module 106a, the RAG module 106b, the agent module 106c, and the neural language model 108 during their respective operations. The set of events may comprise agent communications between multiple artificial intelligence agents of the artificial intelligence application, retrieval-augmented generation operations, tool call events, tool output events, prompt events, response events, or any combination thereof.

In an embodiment of the disclosure, the intercepting of the set of events comprises using at least one of a function wrapper applicable to a function of the artificial intelligence application 106, a gateway that proxies requests to the artificial intelligence application 106, or a framework-specific adapter integrated with an artificial intelligence framework executing the artificial intelligence application 106. In an embodiment of the disclosure, the function wrapper may be implemented as a decorator-based integration mechanism provided through a software development kit. The decorator may be initialized with an application programming interface key and may be applied to functions of the artificial intelligence application 106 to intercept function calls. During an initialization phase, the software development kit may download all enabled policies associated with the application programming interface key from the Command Center interface and cache the policies locally. During a runtime phase, the decorator may intercept function calls, extract input data including prompts and context information, send the extracted data to a policy server (such as the computing system 102) with a policy identifier, receive a security decision indicating whether the operation should be allowed or denied, and either allow execution to proceed or raise a policy violation error based on the verdict. For example, a single policy decorator may be applied to a function with a policy_id parameter that links to a comprehensive policy in the Command Center, simplifying integration for developers who need to only add the decorator once without requiring ongoing code modifications.

In an embodiment of the disclosure, the gateway-level integration may enable organizations to apply policies at an organizational level without requiring modifications to application code, allowing security teams to deploy policies that apply to all deployed agents without developer involvement. For example, a gateway may act as a transparent proxy similar to a straight-through processing gateway, where all AI requests and responses pass through the gateway, and organization-level policies such as “All apps should not send anything to external domains” may be applied without requiring developers to change code. The gateway may see all request and response traffic and enforce input and output policies across all deployed agents.

At 206, the operations include evaluating the set of events against the compiled policy representation. In an embodiment of the disclosure, the computing system 102 is configured to evaluate the set of events through a process that matches events to applicable policy conditions and applies security check functions to generate policy evaluation results. The evaluating of the set of events against the compiled policy representation comprises matching the set of events to at least one resource type of the set of resource types to identify applicable policy conditions in the compiled policy representation, and applying a subset of security check functions to the set of events to generate policy evaluation results. The set of security check functions includes the subset of security check functions associated with the applicable policy conditions.

At 208, the operations include matching the set of events to at least one resource type of a set of resource types to identify applicable policy conditions in the compiled policy representation. In an embodiment of the disclosure, the matching of the set of events comprises indexing policy conditions in the compiled policy representation by the set of resource types, determining a resource type from the set of resource types corresponding to each event in the set of events, and identifying the applicable policy conditions indexed to the determined resource type. For example, when an event comprises a user prompt, the computing system 102 may determine the resource type as a message input resource and identify policy conditions specifically indexed to message input resources, such as prompt injection detection rules and jailbreak detection rules. When an event comprises a tool invocation, the computing system 102 may determine the resource type as a tool call resource and identify policy conditions indexed to tool call resources, such as privilege escalation prevention rules and data exfiltration monitoring rules.

In an embodiment of the disclosure, the policy indexing enables rapid identification of applicable rules when events are received. For example, a policy index may be structured as a mapping where “message. input” maps to rules 1, 2, and 5, “tool_call” maps to rules 3 and 4, and “agent_message” maps to rules 6, 7, and 8. When a request comes in with a resource type of “message. input”, only the 3 relevant rules are evaluated rather than all 8 rules, resulting in 40-60% faster rule lookup. This indexing approach enables efficient policy enforcement by avoiding unnecessary evaluation of rules that do not apply to the current event type.

In an embodiment of the disclosure, an example RAG security policy may be expressed in the domain-specific policy grammar to address retrieval-augmented generation security concerns. The policy may be named “RAGSecurityPolicy” and may include multiple rules for securing RAG operations. A first rule may deny retrieval resources where the check_rag_authenticity function applied to sources returns false, with options specifying trusted domains such as “example.org” and “trusted-source.com”, verifying source authenticity against a list of trusted domains. A second rule may deny embedding resources where the check_embedding_tampering function applied to vectors returns a value exceeding a detection threshold such as 0.75, detecting embedding manipulation attempts based on geometric constraints. A third rule may allow RAG resources where the check_chunk_consistency function applied to chunks and original text returns true, ensuring consistency between retrieved chunks and original text. This example demonstrates how the policy grammar enables expression of security policies for retrieval-augmented generation systems.

In an embodiment of the disclosure, an example output validation policy may be expressed in the domain-specific policy grammar to address output safety concerns. The policy may be named “OutputSafetyPolicy” and may include rules for validating model outputs. A first rule may deny response resources where the check_pii function applied to content detects personally identifiable information of types including SSN, CREDIT_CARD, and ADDRESS with a confidence threshold of 0.7. A second rule may deny response resources where the check_output function applied with a “factual_consistency” output type returns a score below a minimum threshold of 0.6, with citation validation enabled. A third rule may deny message output resources where the check_output function applied with a “toxicity” output type exceeds a threshold of 0.7 for categories including hate, violence, and self-harm. This example demonstrates how the policy grammar enables expression of output validation policies.

In an embodiment of the disclosure, an extended output validation policy may include additional rules for comprehensive output security. The extended policy may be named “OutputValidationPolicy” and may include rules for harmful content detection, hallucination detection, PII and sensitive data leakage prevention, and personality drift detection. A rule for harmful content may deny message output resources where the check_output function with a “toxicity” output type exceeds a threshold of 0.7 for categories including hate, violence, self-harm, and sexual content. A rule for hallucination detection may deny response resources where the check_output function with a “factual_consistency” output type returns a score below 0.6, with validation against retrieved context and knowledge base sources. A rule for PII leakage prevention may deny message output resources where the check_pii function detects types including SSN, CREDIT_CARD, ADDRESS, EMAIL, and PHONE with a confidence threshold of 0.8. A rule for personality drift may deny response resources where the check_model function with a “personality_drift” behavior type returns false, with a baseline set to the system prompt and a consistency threshold of 0.85.

In an embodiment of the disclosure, an example token-level security policy may be expressed in the domain-specific policy grammar to address token-level security concerns. The policy may be named “TokenLevelSecurity” and may include rules for monitoring token distributions and patterns. A first rule may deny message output resources where the check_tokens function with a “distribution” token type detects divergence from a reference distribution exceeding a maximum divergence threshold of 0.3, with the reference distribution set to a model baseline. A second rule may deny message input resources where the check_token_entropy function applied to content detects entropy outside acceptable bounds, with a minimum entropy of 2.0, maximum entropy of 6.0, and window size of 50 tokens. A third rule may deny response resources where the check_tokens function with a “repetition” token type detects excessive repetition, with a maximum repetition ratio of 0.2 and minimum unique tokens of 20. A fourth rule may deny message input resources where the check_tokens function with a “sequence_pattern” token type detects suspicious patterns such as “[START] [SYSTEM] [IGNORE]” or “[DELIM] [BYPASS] [INSTR]”. This example demonstrates how the policy grammar enables expression of token-level security policies.

In an embodiment of the disclosure, an example multiagent security policy may be expressed in the domain-specific policy grammar to address multiagent interaction security concerns. The policy may be named “MultiagentSecurityPolicy” and may include rules for securing agent-to-agent communications. A first rule may deny message resources where source_agent and target_agent are both present, but the verify_agent_communication function applied to source_agent, target_agent, and content returns false, securing agent-to-agent communication. A second rule may deny message resources where the source agent trust level exceeds the target agent trust level and the content contains sensitive information at the source agent trust level, controlling information flow between agents with different trust levels. A third rule may deny tool_call resources where the delegated_from attribute is present but the delegating agent permissions do not contain the requested tool name, preventing privilege escalation through delegation. A fourth rule may deny trace resources where the detect_agent_collusion function applied to the trace detects collusion patterns including circular_delegation and hidden_channels with a threshold of 0.8, detecting potential collusion between agents. A fifth rule may deny message resources where the verify_agent_identity function applied to source_agent returns false, with signature checking enabled and a maximum token age of 3600 seconds, verifying agent identity using cryptographic signatures.

In an embodiment of the disclosure, an example encryption policy may be expressed in the domain-specific policy grammar to address encryption and key management concerns. The policy may be named “EncryptionPolicy” and may include rules for securing sensitive data and cryptographic operations. A first rule may deny message resources where the content contains sensitive data, but the validate_encryption function returns false, with options specifying a minimum encryption strength of AES-256 and algorithm checking enabled, enforcing encryption for sensitive data. A second rule may deny key resources where the check_key_rotation function applied to the key identifier returns false, with options specifying a maximum age of 90 days, usage count checking enabled, and maximum usage of 1000 operations, ensuring key rotation compliance. A third rule may deny tool_output resources where the content is external content, but the verify_signatures function returns false, with options specifying trusted keys from an authorized key list and revocation checking enabled, verifying signatures for external content. A fourth rule may deny key resources where the operation equals “decrypt,” but the user_has_permission function returns false for the user identifier, “decrypt” operation, and resource identifier, controlling access to encryption operations.

At 210, the operations include applying a subset of security check functions to the set of events to generate policy evaluation results. In an embodiment of the disclosure, the computing system 102 is configured to apply security check functions associated with the resource types identified at 208. The set of security check functions associated with the set of resource types comprises at least one of prompt injection detection functions, output validation functions, agent identity verification functions, embedding tampering detection functions, source authentication functions, data leakage detection functions, personally identifiable information detection functions, encryption validation functions, signature verification functions, or collusion detection functions.

In an embodiment of the disclosure, the set of security check functions incorporates deterministic rules including at least one of regex patterns, blacklists, whitelists, or threshold comparisons with machine learning models for specific security tasks. For example, prompt injection detection functions may first apply regex patterns to identify known attack signatures, then use specialized machine learning models to analyze suspicious content patterns, and finally apply threshold comparisons to determine if the content exceeds acceptable risk levels. Each security check function may combine a model call with a specialized classifier trained for the specific security task (not a large language model, but a lightweight classifier with fast inference), regex patterns for known attack signatures, and threshold comparisons against configured values. A tagging model may run before specific checks to tag text as “system prompt” versus “user prompt” and identify intent such as “system prompt hack”, with tags influencing downstream threshold assignments where higher scrutiny is applied when suspicious intent is detected.

In an embodiment of the disclosure, the applying of the subset of security check functions comprises applying a first tier of security check functions of the subset of security check functions based on at least one of pattern matching, hash lookups, or bloom filters. Based on results of the first tier of security check functions, the computing system 102 applies a second tier of security check functions of the subset of security check functions to traverse the compiled policy representation 110. Based on results of the second tier of security check functions, the computing system 102 applies a third tier of security check functions of the subset of security check functions. The third tier of security check functions uses machine learning models. For example, the first tier may include exact pattern matching for common attack patterns, resource type validation, and permission boundary checks using bloom filters and hash lookups for rapid filtering. The second tier may include DAG traversal with short-circuit evaluation, basic function evaluations including regex and comparisons, and cached results for repeated subexpressions. The third tier may include ML-based detection models, embedding comparisons, and pattern analysis across event history.

In an embodiment of the disclosure, when the set of events comprises retrieval-augmented generation operations, the subset of security check functions comprises embedding integrity verification functions that detect manipulated embeddings associated with the retrieval-augmented generation operations based on geometric constraints, and source authentication functions that authenticate sources of documents associated with the retrieval-augmented generation operations. For example, the embedding integrity verification functions may analyze vector embeddings for geometric anomalies that indicate tampering, such as embeddings that violate expected distance relationships or clustering patterns, while source authentication functions may verify cryptographic signatures or validate document origins against trusted source lists. The security check functions may include a check_rag_authenticity function that verifies source authenticity against a list of trusted domains, a check_embedding_tampering function that detects embedding manipulation with a configurable detection threshold, a detect_context_poisoning function for identifying context poisoning attacks, a verify_source_integrity function for validating source integrity, and a check_chunk_consistency function that validates consistency between retrieved chunks and original text using cross-encoder models to verify semantic integrity and detect subtle manipulations that evade syntactic checks.

In an embodiment of the disclosure, when the set of events comprises agent communications between multiple artificial intelligence agents of the artificial intelligence application 106, the evaluating of the set of events against the compiled policy representation comprises analyzing the agent communications to detect collusion patterns among the multiple artificial intelligence agents, and the policy evaluation results include the collusion patterns. The collusion patterns comprise at least one of circular delegation patterns, suspicious information flow patterns, or privilege escalation patterns. The analyzing of the agent communications to detect the collusion patterns comprises constructing an interaction graph representing the agent communications between the multiple artificial intelligence agents, detecting cycles in the interaction graph based on graph-based analysis to identify the circular delegation patterns, analyzing information flow between the multiple artificial intelligence agents based on the agent communications to identify the suspicious information flow patterns, and monitoring privilege escalation by calculating effective permissions of the multiple artificial intelligence agents based on the agent communications and cryptographically verifying delegation records associated with the calculated effective permissions to identify the privilege escalation patterns.

In an embodiment of the disclosure, the graph-based analysis for detecting circular delegation patterns may construct an interaction graph where nodes represent agents and edges represent interactions including messages, tool invocations, and data transfers. The computing system 102 may apply specialized graph algorithms to detect cycles and suspicious subgraphs, where for each cycle containing delegation edges, the computing system 102 calculates privilege accumulation across the cycle and computes a suspicion score based on cycle length, privilege accumulation, and edge timing patterns. The computing system 102 may also detect clique patterns representing potential collusion groups by finding maximal cliques and calculating information flow density within each clique and external information leakage to identify suspicious patterns.

In an embodiment of the disclosure, the information flow analysis may build an information flow graph from interactions and track sensitive information propagation by identifying propagation paths from sensitive data sources. For each path, the computing system 102 checks if the path violates information flow policies based on the data classification and calculates a flow suspicion score based on path length, traversal time, and agent trust levels. The computing system 102 may also detect information laundering patterns where information passes through intermediate agents to disguise its source. The temporal analysis may group interactions by agent pairs, extract interaction timestamps, perform regularity analysis to calculate regularity scores, and perform correlation analysis with other agent pairs to find timing correlations that may indicate coordinated communications.

In an embodiment of the disclosure, the privilege escalation monitoring may track privilege changes over time by building privilege timelines for each agent and identifying significant privilege increases. For each increase, the computing system 102 checks if the increase is authorized and calculates escalation severity based on the difference between before and after privileges. Unauthorized increases exceeding an escalation threshold are reported as privilege escalation patterns. The security check functions for multiagent systems may include a verify_agent_identity function that performs cryptographic identity verification with signature checking and maximum token age parameters, a verify_agent_communication function that validates communication authenticity between source and target agents, a detect_agent_collusion function that analyzes traces for collusion patterns including circular delegation and hidden channels with a configurable threshold, a check_agent_permissions function that validates agent authorization for requested operations, a validate_agent_delegation function that verifies delegation chains between agents, and an analyze_agent_interaction_patterns function for analyzing agent interaction patterns.

At 212, the operations include determining a security decision based on the policy evaluation results generated at 210. In an embodiment of the disclosure, the computing system 102 is configured to analyze the results from the security check functions to determine whether the events should be allowed, denied, or subjected to additional scrutiny. The security decision may be based on the evaluation of multiple security check functions, with the compiled policy representation 110 implementing logical relationships between different policy conditions to arrive at a final determination.

In an embodiment of the disclosure, the compiled policy representation 110 may implement the logical relationships using AND and OR logic to combine results from multiple security check functions. When AND logic is specified, all checks must pass for the event to be allowed, enabling sequential evaluation with fail-fast behavior where evaluation stops as soon as any check fails. When OR logic is specified, any check failing triggers a violation, enabling parallel evaluation where multiple checks execute simultaneously and evaluation stops as soon as any check detects a violation. The compiled policy representation 110 may implement lazy expression evaluation similar to compiler optimization, where expressions such as a first condition AND, a second condition AND, and a check function are evaluated left to right, and if the first condition is false, the second condition and the check function are never evaluated, saving computation time.

In an embodiment of the disclosure, the computing system 102 may implement incremental evaluation techniques that avoid redundant computation when evaluating multiple related policies. For example, for a policy specifying “Don't send email to John” AND “Don't send email to Harry”, rather than loading the email and comparing with “John” in a first check and loading the email again and comparing with “Harry” in a second check, the incremental approach loads the email once into a stack, puts [“John”, “Harry”] in a lookup table or hash, and performs a single hash check against the table for faster iteration. Pre-defined values in the policy may be kept in a lookup table instead of being allocated at runtime, enabling O(1) lookups instead of O(n) comparisons. The computing system 102 may also implement expression caching where results of common subexpressions are cached to avoid redundant evaluation, and function result memoization where results of deterministic security check functions are memoized to avoid recomputation when the same function is called with the same arguments.

At 214, the operations include causing enforcement of the security decision on the artificial intelligence application 106. In an embodiment of the disclosure, the causing of the enforcement of the security decision comprises at least one of blocking or allowing execution of operations associated with the set of events based on the security decision, or identifying, from the set of events, a subset of events violating the security policy 112 to generate violation data for the subset of events. For example, if a prompt injection attack is detected using the security check functions at 210, operation at 214 may block the processing of the malicious prompt and generate violation data for security monitoring and incident response. The enforcement may be applied to various components of the artificial intelligence application 106, including preventing the neural language model 108 from processing malicious prompts, blocking unauthorized tool calls from the tool calling module 106a, preventing suspicious agent communications in the agent module 106c, or stopping retrieval operations that involve manipulated embeddings in the RAG module 106b.

In an embodiment of the disclosure, the enforcement actions may include allowing the request to proceed normally, denying the request immediately, blocking or unblocking specific entities persistently, escalating to a human user for decision through a user-in-the-loop mechanism, or routing to a security analyst through an escalation flow. The computing system 102 may integrate with existing security infrastructure including security information and event management systems, messaging platforms, and security analyst tools to handle escalation playbooks. After violation detection, all inputs, outputs, and context may be stored in a telemetry server to maintain a complete audit trail for forensic analysis and compliance reporting. The decorator-based integration may raise a policy violation error containing the violation type, the policy rule violated, the input and output data, and timestamp and context information, enabling application code of the artificial intelligence application 106 to handle violations appropriately.

In an embodiment of the disclosure, the computing system 102 may support multiple deployment models to accommodate different security requirements and operational constraints. An inline enforcement model enforces policies directly within the AI system's request processing pipeline. An asynchronous monitoring model evaluates policies asynchronously alongside normal system operation, logging violations without blocking requests. A hybrid approach enforces critical security policies inline while evaluating less critical policies asynchronously. A federated enforcement model distributes policy enforcement across different components in distributed AI ecosystems, with local policy engines communicating to enforce system-wide policies.

The flowchart 200 demonstrates the comprehensive policy-based security enforcement process that enables deterministic control over artificial intelligence application security through systematic event interception, resource type matching, security function application, and decision enforcement. The process may be executed continuously during runtime operations of the artificial intelligence application 106, providing real-time security monitoring and enforcement across all components of the artificial intelligence application 106. The Command Center interface accessible through the user interface 122 may enable dynamic policy updates that modify the behavior of the compiled policy representation 110 without requiring code changes or application restarts, allowing security teams to adapt to emerging threats and changing organizational requirements through the natural language policy input capabilities provided by the input 124 and neural language model 108. Policies may be enabled or disabled dynamically in the Command Center, and changes may take effect immediately across deployed applications.

In an embodiment of the disclosure, the deterministic nature of the policy-based security enforcement addresses limitations of existing security approaches that rely on non-deterministic enforcement mechanisms. Unlike trained classifier models with fixed parameters that produce probabilistic outputs, large language model as judge approaches that can be manipulated through sophisticated prompt injection attacks, or hard-coded security functions embedded directly in application code that create rigid systems unable to adapt to evolving threats without extensive code modifications, the policy-based approach provides deterministic control through the combination of formal rules and specialized machine learning models within the domain-specific policy grammar. The separation of concerns between policy definition and enforcement enables security teams to control policy specifications through the Command Center interface while development teams integrate enforcement mechanisms once through the decorator-based integration without requiring ongoing code modifications as security requirements evolve. The grammar file serves as core intellectual property similar to a vocabulary file in a large language model, defining all allowed keywords and constructs and enabling rapid adaptation to the evolving AI ecosystem, such as adding support for newer protocols like Model Context Protocol with minimal changes to the grammar file.

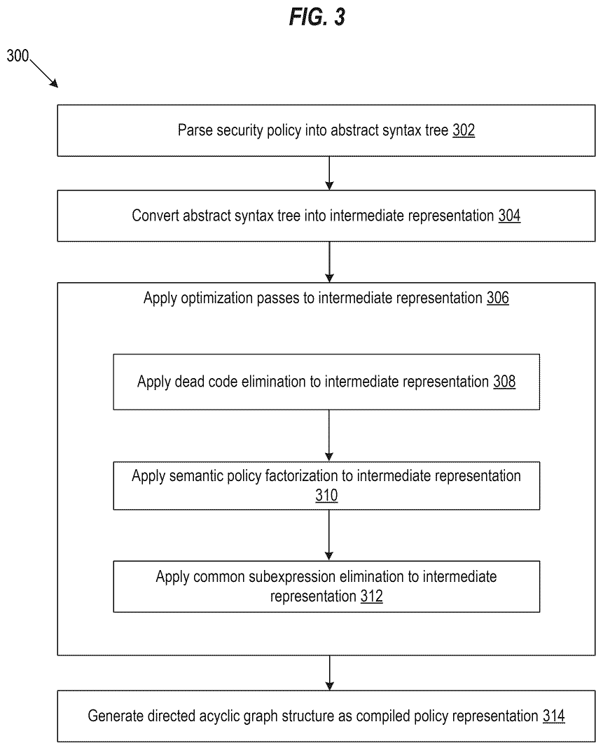

FIG. 3 is a diagram that illustrates a flowchart 300 depicting a policy compilation process for transforming security policies into optimized compiled representations, in accordance with an embodiment of the disclosure. FIG. 3 is explained in conjunction with elements from FIG. 1 and FIG. 2. With reference to FIG. 3, there is shown the flowchart 300. The operations of the flowchart 300 may be executed by any computing system, for example, by the computing system 102 of FIG. 1. The operations of the flowchart 300 may start at 302.

At 302, the operations include parsing a security policy into an abstract syntax tree. In an embodiment of the disclosure, the computing system 102 is configured to parse the security policy 112 written in the domain-specific policy grammar into an abstract syntax tree representation. The domain-specific policy grammar defines syntax for expressing a plurality of security policies specific to a plurality of artificial intelligence applications using a context-free grammar. The plurality of security policies include the security policy 112 associated with the artificial intelligence application 106 and the plurality of artificial intelligence applications include the artificial intelligence application 106. The context-free grammar may be formally defined with non-terminal symbols representing policy constructs, terminal symbols representing keywords, operators, and literals, production rules defining syntax, and a start symbol representing the policy set. The parsing operation may be performed using a parser such as an ANTLR4-based parser that converts policy text into an abstract syntax tree structure. For example, a policy rule such as “deny message input where check_prompt_injection(content)>0.8” may be parsed into an abstract syntax tree having a rule node with an effect child node containing “DENY”, a resource child node containing “message. input”, and a condition child node containing a comparison node with a function node for “check_prompt_injection(content)” and a value node for “0.8”. The abstract syntax tree captures the hierarchical structure of the policy while preserving the semantic relationships between policy elements. The parsing operation transforms the textual policy representation into a structured form that enables subsequent optimization and compilation stages.

At 304, the operations include converting the abstract syntax tree into an intermediate representation. In an embodiment of the disclosure, the computing system 102 is configured to transform the abstract syntax tree generated at 302 into an intermediate representation suitable for optimization. The intermediate representation provides a normalized form of the policy that enables systematic application of optimization techniques. The conversion process may flatten nested structures, normalize expressions, and annotate nodes with type information and dependency relationships. The intermediate representation serves as a bridge between the human-readable policy syntax and the optimized execution structure, enabling the computing system 102 to apply various optimization passes without modifying the original policy specification.

At 306, the operations include applying optimization passes to the intermediate representation. In an embodiment of the disclosure, the computing system 102 is configured to apply multiple optimization passes to the intermediate representation to generate an optimized compiled policy representation. The optimization passes include at least one of constant folding operation, dead code elimination, semantic policy factorization, or common subexpression elimination. This encompasses multiple sub-operations including an operation at 308, an operation at 310, and an operation at 312, each representing a specific optimization technique applied to the intermediate representation. The optimization passes may be applied in sequence, with each pass transforming the intermediate representation.

At 308, the operations include applying dead code elimination to the intermediate representation. In an embodiment of the disclosure, the computing system 102 is configured to identify and remove unreachable rules and conditions from the intermediate representation. Dead code elimination analyzes the policy file to identify rules that can never be triggered based on the logical relationships between conditions, resource type constraints, or conflicting rule specifications. For example, if a policy file contains a rule that denies all message inputs followed by a rule that allows specific message inputs, the dead code elimination pass may identify that the second rule is unreachable and remove the second rule from the intermediate representation. The dead code elimination reduces the size of the compiled policy representation and eliminates unnecessary evaluation paths during runtime execution.

At 310, the operations include applying semantic policy factorization to the intermediate representation. In an embodiment of the disclosure, the computing system 102 is configured to decompose complex policies into semantically equivalent sub policies that can be evaluated more efficiently. The applying of the semantic policy factorization comprises converting the security policy 112 to disjunctive normal form, extracting terms from the disjunctive normal form, building a term dependency graph based on the extracted terms, identifying independent subgraphs in the term dependency graph, and identifying parallelizable components in the intermediate representation based on the independent subgraphs. The semantic policy factorization algorithm reduces evaluation complexity from O(n·k) to O(n log k) for policies with n conditions and k integration points. For example, a policy with multiple independent conditions such as a toxicity check, a PII detection check, and a prompt injection check may be factorized into separate sub policies that can be evaluated in parallel, with the results combined according to the logical relationships specified in the original policy.

In an embodiment of the disclosure, the semantic policy factorization process begins by converting the security policy 112 to disjunctive normal form, which represents the policy as a disjunction of conjunctive clauses. The computing system 102 extracts all unique terms from the disjunctive normal form clauses and builds a term dependency graph where nodes represent terms and edges represent dependencies between terms. The computing system 102 identifies independent subgraphs in the term dependency graph, where each independent subgraph represents a set of terms that can be evaluated independently of other subgraphs. For each independent subgraph, the computing system 102 extracts a sub policy from the disjunctive normal form and applies specialized optimizations including resource-specific optimizations for sub policies targeting specific resource types, function-specific optimizations for sub policies containing function calls, and caching optimizations for sub policies with repeated subexpressions. The computing system 102 creates an optimized policy evaluation plan that specifies how the factorized sub policies should be combined to produce the final policy evaluation result. The semantic policy factorization enables identification of semantically independent components that can be evaluated in parallel, application of specialized optimizations to resource-specific and function-specific sub policies, creation of optimal evaluation plans based on the cost and selectivity of each sub policy, and effective caching of intermediate results across multiple policy evaluations.

At 312, the operations include applying common subexpression elimination to the intermediate representation. In an embodiment of the disclosure, the computing system 102 is configured to identify expressions that appear multiple times within the policy and consolidate the expressions to avoid redundant evaluation. For example, if multiple rules check the same condition such as “user. role ==guest”, the common subexpression elimination pass identifies the repeated condition and restructures the intermediate representation so that the condition is evaluated once and the result is reused across all rules that reference the condition. The common subexpression elimination reduces computational overhead during runtime evaluation by avoiding duplicate computation of identical expressions. The computing system 102 may implement expression caching where results of common subexpressions are cached to avoid redundant evaluation, achieving reduction in evaluation time for policies with repeated conditions. In an embodiment of the disclosure, for a policy specifying conditions such as “Don't send email to John” AND “Don't send email to Harry”, rather than loading the email and comparing with “John” in a first check and loading the email again and comparing with “Harry” in a second check, the common subexpression elimination approach loads the email once into a stack, places the values “John” and “Harry” in a lookup table or hash, and performs a single hash check against the table for faster iteration. Pre-defined values in the policy may be kept in a lookup table instead of being allocated at runtime, enabling O(1) lookups instead of O(n) comparisons.

At 314, the operations include generating a directed acyclic graph structure as the compiled policy representation. In an embodiment of the disclosure, the computing system 102 is configured to generate the compiled policy representation 110 as a directed acyclic graph structure having nodes representing atomic policy conditions of the security policy 112 and edges representing logical relationships between the atomic policy conditions. The parallelizable components identified in the intermediate representation through the semantic policy factorization (at 310) are represented as parallelizable nodes in the directed acyclic graph structure. The directed acyclic graph structure enables efficient runtime evaluation through parallel evaluation of the parallelizable nodes against the set of events intercepted from the artificial intelligence application 106. Nodes in the directed acyclic graph structure represent atomic policy conditions including individual checks such as toxicity threshold comparisons, actions including terminal decisions of allow or deny, resource types indicating what is being checked, function calls representing security check invocations, and logical relationships including AND, OR, and NOT operators. Edges in the directed acyclic graph structure represent the logical flow between conditions. The directed acyclic graph structure serves multiple purposes including optimization for speed by finding the fastest path through rule checks and enabling fail-fast evaluation, conflict resolution by handling conflicting policies such as “allow . io domains” versus “deny mirror. io domain” and prioritizing more specific rules over general ones, and dependency management by identifying the best path based on dependencies and input structure.

In an embodiment of the disclosure, the compiled policy representation 110 may be created at runtime rather than pre-compiled, allowing for dynamic optimization based on actual input and execution context. The runtime creation of the directed acyclic graph structure enables the computing system 102 to adapt the evaluation strategy based on the specific characteristics of incoming events, the current system state, and performance requirements. For example, when the computing system 102 receives a set of events from the artificial intelligence application 106, the computing system 102 may dynamically construct or modify the directed acyclic graph structure to optimize evaluation for the specific resource types and conditions relevant to the received events. The runtime creation approach enables non-deterministic directed acyclic graph structure optimization for speed while maintaining deterministic output, where the evaluation path through the graph may vary based on optimization decisions but the final security decision remains consistent for identical inputs and policy specifications.

In an embodiment of the disclosure, the computing system 102 makes intelligent decisions about sequential versus parallel execution, where a small number of checks such as two checks may be executed sequentially while a larger number of checks such as five or six checks may be executed in parallel based on the number and independence of checks. The computing system 102 may prioritize native functions including regex and lookups with higher priority for execution first, while external functions including model calls and enrichment have lower priority and are executed later. User-configurable thresholds may influence prioritization, where higher threshold values result in higher priority in execution order, such as a self-harm check having higher priority than a general toxicity check.

In an embodiment of the disclosure, the policy compilation process illustrated in the flowchart 300 enables the computing system 102 to transform human-readable security policies written in the domain-specific policy grammar into optimized execution structures suitable for efficient runtime evaluation. The compilation process may be performed when policies are initially defined, when policies are updated through the Command Center interface accessible via the user interface 122, or dynamically at runtime when the computing system 102 determines that recompilation would improve evaluation performance for specific workload patterns. The compiled policy representation 110 generated through the flowchart 300 enables the policy evaluation operations described in the flowchart 200 of FIG. 2, providing the optimized data structure against which the set of events from the artificial intelligence application 106 are evaluated to determine security decisions. In an embodiment of the disclosure, the policy compilation process implements additional runtime optimization techniques including policy indexing by resource type, function result memoization for deterministic operations, and just-in-time compilation for performance-critical policies.

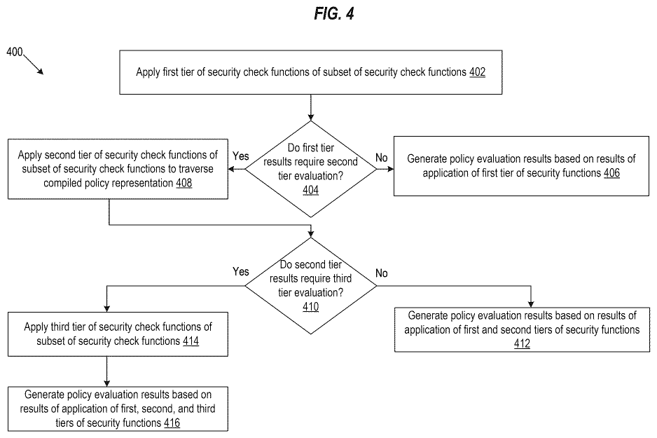

FIG. 4 is a diagram that illustrates a flowchart 400 depicting a multi-tier policy evaluation process for applying security check functions progressively based on results of preceding tiers, in accordance with an embodiment of the disclosure. FIG. 4 is explained in conjunction with elements from FIG. 1, FIG. 2, and FIG. 3. With reference to FIG. 4, there is shown the flowchart 400. The operations of the flowchart 400 may be executed by any computing system, for example, by the computing system 102 of FIG. 1. The operations of the flowchart 400 may start at 402.

At 402, the operations include applying a first tier of security check functions of a subset of security check functions. In an embodiment of the disclosure, the computing system 102 is configured to apply the first tier of security check functions based on at least one of pattern matching, hash lookups, or bloom filters. The first tier of security check functions comprises lightweight checks designed for rapid filtering of events intercepted from the artificial intelligence application 106. The first tier may include exact pattern matching for common attack patterns, resource type validation, permission boundary checks, bloom filter lookups for known malicious signatures, and hash-based comparisons against blacklists and whitelists. The first tier of security check functions prioritizes deterministic rules over machine learning models to enable fail-fast evaluation, where violations detected at the first tier result in immediate security decisions without requiring evaluation by subsequent tiers. In an embodiment of the disclosure, native functions including regex and lookups are assigned higher priority for execution first, while external functions including model calls and enrichment have lower priority and are executed later, enabling fail-fast at initial stages. For example, when the computing system 102 intercepts a message input event from the neural language model 108, the first tier may apply regex patterns to detect known prompt injection signatures, perform hash lookups against a blacklist of prohibited phrases, and use bloom filters to identify potential attack patterns, all within a short time period due to the computational efficiency of the first tier operations. In an embodiment of the disclosure, for a policy specifying conditions such as “Don't send email to John” AND “Don't send email to Harry”, rather than loading the email and comparing with “John” in a first check and loading the email again and comparing with “Harry” in a second check, the first tier approach loads the email once into a stack, places the values “John” and “Harry” in a lookup table or hash, and performs a single hash check against the table for faster iteration, enabling constant-time lookups instead of linear-time comparisons.

At 404, the operations include determining whether the first tier results require second tier evaluation. In an embodiment of the disclosure, the computing system 102 is configured to analyze the results from the first tier of security check functions applied at 402 to determine whether additional evaluation is warranted. If the first tier results indicate a clear violation or a clear pass based on the deterministic rules applied, the computing system 102 may proceed directly to generating policy evaluation results without invoking subsequent tiers. In an embodiment of the disclosure, the computing system 102 makes intelligent decisions about sequential versus parallel execution, where a small number of checks may be executed sequentially while a larger number of checks may be executed in parallel based on the number and independence of checks. If the first tier results require second tier evaluation (Yes branch), control passes to 408. Otherwise, if the first tier results do not require second tier evaluation (No branch), control passes to 406.

At 406, the operations include generating policy evaluation results based on results of application of the first tier of security functions. In an embodiment of the disclosure, the computing system 102 is configured to generate policy evaluation results when the first tier of security check functions provides sufficient information to determine a security decision. The policy evaluation results generated at 406 may indicate that the set of events should be allowed because the first tier checks passed without detecting any violations, or that the set of events should be denied because the first tier checks detected a clear violation such as a known attack pattern or blacklisted content. The ability to generate policy evaluation results based solely on the first tier enables efficient policy enforcement by avoiding unnecessary computation when earlier tiers provide sufficient information for a security decision. In an embodiment of the disclosure, the first tier evaluation supports lazy expression evaluation similar to compiler optimization, where for a condition such as “condition1 && condition2 && expensive_check( )”, if condition1 is false, condition2 is never evaluated and expensive_check( ) is never called, saving computation time through short-circuit evaluation. After generating the policy evaluation results at 406, control passes to 418.

At 408, the operations include applying a second tier of security check functions of the subset of security check functions to traverse the compiled policy representation 110. In an embodiment of the disclosure, the computing system 102 is configured to apply the second tier of security check functions when the first tier results indicate that additional evaluation is warranted. The second tier of security check functions may include directed acyclic graph traversal with short-circuit evaluation, basic function evaluations including regex comparisons and threshold checks, and cached results for repeated subexpressions. The second tier traverses the compiled policy representation 110 to evaluate policy conditions that require more detailed analysis than the first tier provides. The second tier may include application of security check functions that combine deterministic rules with lightweight computational operations, such as comparing extracted values against configured thresholds, evaluating logical expressions combining multiple conditions, and checking resource-specific constraints defined in the security policy 112. In an embodiment of the disclosure, before specific checks are applied, a tagging model runs that tags text as “system prompt” versus “user prompt”, identifies intent such as “system prompt hack”, and assigns tags that influence downstream threshold assignments, where if intent is identified as “system prompt hack” the content receives higher scrutiny in subsequent evaluation. The second tier maintains the fail-fast evaluation approach by short-circuiting evaluation when a definitive result is determined.

At 410, the operations include determining whether the second tier results require third tier evaluation. In an embodiment of the disclosure, the computing system 102 is configured to analyze the results from the second tier of security check functions applied at 408 to determine whether the third tier of security check functions should be invoked. In an embodiment of the disclosure, user-configurable thresholds may influence prioritization, where higher threshold values result in higher priority in execution order, such as a self-harm check having higher priority than a general toxicity check. If the second tier results require third tier evaluation (Yes branch), control passes to 414. Otherwise, if the second tier results do not require third tier evaluation (No branch), control passes to 412.

At 412, the operations include generating policy evaluation results based on results of application of the first and second tiers of security functions. In an embodiment of the disclosure, the computing system 102 is configured to generate policy evaluation results that incorporate the analysis from both the first tier and the second tier of security check functions. The policy evaluation results generated at 412 reflect the combined evaluation of lightweight pattern matching and hash lookups from the first tier with the directed acyclic graph traversal and threshold comparisons from the second tier. In an embodiment of the disclosure, the computing system 102 implements expression caching where results of common subexpressions are cached to avoid redundant evaluation, achieving a reduction in evaluation time for policies with repeated conditions. After generating the policy evaluation results at 412, control passes to 418.

At 414, the operations include applying a third tier of security check functions of the subset of security check functions. In an embodiment of the disclosure, the computing system 102 is configured to apply the third tier of security check functions when the second tier results indicate that machine learning-based analysis is warranted. The third tier of security check functions uses machine learning models for specific security tasks that exceed the capabilities of rule-based systems alone. The third tier may include machine learning-based detection models for prompt injection, toxicity classification, personally identifiable information detection, embedding comparisons for detecting manipulated vectors, and pattern analysis across event history for detecting sophisticated attack patterns. In an embodiment of the disclosure, each category check such as toxicity includes a model call to a small specialized model trained for that specific check, which is not a large language model call but rather a lightweight classifier such as a toxicity model or PII detection model, combined with regex patterns for known patterns and threshold checks for final comparison against configured thresholds. The third tier of security check functions combines the deterministic rules evaluated in preceding tiers with machine learning models trained for specific security tasks, where the machine learning models provide probabilistic scores that are compared against configured thresholds to generate deterministic security decisions. For example, when evaluating output from the neural language model 108, the third tier may apply a toxicity classifier to generate a toxicity score, apply a personally identifiable information detection model to identify sensitive data, and apply a factual consistency model to detect hallucinations, with each model output compared against policy-defined thresholds to determine whether the output violates the security policy 112. In an embodiment of the disclosure, for an output validation policy specifying checks for categories including toxicity, hate, violence, and self-harm, the toxicity, hate, violence, and self-harm checks may be executed in parallel, with hallucination checks and PII checks also running in parallel as part of the same directed acyclic graph evaluation, where AND logic enables sequential evaluation with fail-fast capability and OR logic enables parallel evaluation with fail-fast when any check fails.

At 416, the operations include generating policy evaluation results based on results of application of the first, second, and third tiers of security functions. In an embodiment of the disclosure, the computing system 102 is configured to generate comprehensive policy evaluation results that incorporate the analysis from all three tiers of security check functions. The policy evaluation results generated at 416 reflect the combined evaluation of lightweight pattern matching from the first tier, directed acyclic graph traversal from the second tier, and machine learning-based analysis from the third tier. In an embodiment of the disclosure, the computing system 102 implements function result memoization where results of deterministic security check functions are memoized to avoid recomputation when the same function is called with the same arguments, achieving a reduction in computation for repeated checks. After generating the policy evaluation results at 416, control passes to 418.

At 418, the operations include determining a security decision based on the policy evaluation results and causing enforcement of the security decision on the artificial intelligence application 106. In an embodiment of the disclosure, the computing system 102 is configured to receive the policy evaluation results from operations at 406, 412, or 416, and determine a security decision based on the received policy evaluation results. The security decision may comprise allowing execution of operations associated with the set of events, denying execution of operations associated with the set of events, or generating violation data for events that violate the security policy 112. In an embodiment of the disclosure, the enforcement actions may include allowing the request to proceed normally, denying the request immediately, blocking or unblocking specific entities persistently, escalating to a human user for decision through a user-in-the-loop mechanism, or routing to a security analyst through an escalation flow. The computing system 102 causes enforcement of the security decision on the artificial intelligence application 106 by blocking or allowing execution of operations, generating alerts for security monitoring systems, or escalating violations to security personnel through the user interface 122. In an embodiment of the disclosure, after violation detection, all inputs, outputs, and context are stored in a telemetry server to maintain a complete audit trail for forensic analysis and compliance reporting, and the decorator-based integration may raise a policy violation error containing the violation type, the policy rule violated, the input and output data, and timestamp and context information, enabling application code to handle violations appropriately.

In an embodiment of the disclosure, the tiered evaluation strategy illustrated in the flowchart 400 enables efficient policy enforcement by avoiding unnecessary computation when earlier tiers provide sufficient information for a security decision. The tiered approach balances security effectiveness with performance requirements by applying computationally inexpensive checks first and reserving computationally intensive machine learning-based analysis for cases where simpler checks are insufficient. The majority of violations may be detected in the first and second tiers, with a smaller portion requiring the third tier deep analysis, resulting in a significant reduction in evaluation latency compared to approaches that apply all security check functions uniformly.

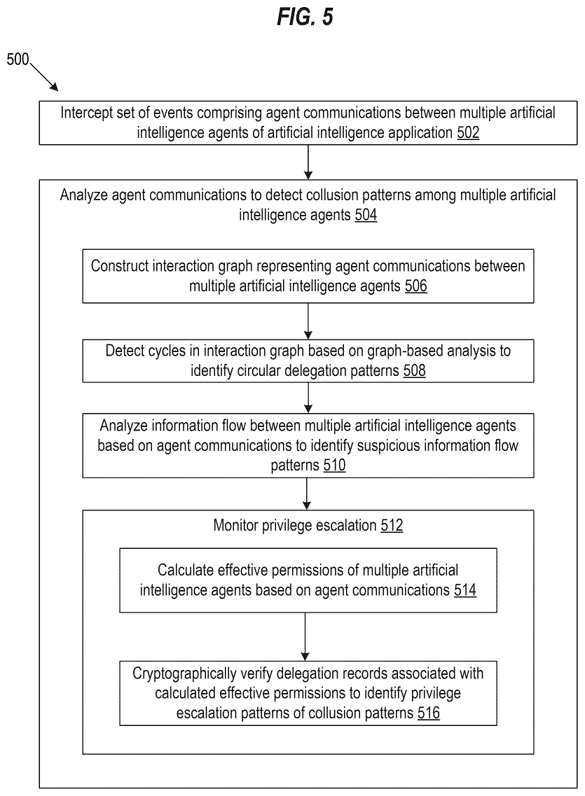

FIG. 5 is a diagram that illustrates a flowchart 500 depicting a process for analyzing agent communications in an artificial intelligence application, in accordance with an embodiment of the disclosure. FIG. 5 is explained in conjunction with elements from FIG. 1, FIG. 2, FIG. 3, and FIG. 4. With reference to FIG. 5, there is shown the flowchart 500. The operations of the flowchart 500 may be executed by any computing system, for example, by the computing system 102 of FIG. 1. The operations of the flowchart 500 may start at 502.

At 502, the operations include intercepting a set of events comprising agent communications between multiple artificial intelligence agents of an artificial intelligence application. In an embodiment of the disclosure, the computing system 102 is configured to intercept agent communications generated by the agent module 106c of the artificial intelligence application 106 during runtime execution on the host system 104. The agent communications may include request messages, response messages, broadcast messages, and private messages exchanged between multiple artificial intelligence agents operating within the artificial intelligence application 106. The agent communications may be intercepted using at least one of a function wrapper applicable to a function of the artificial intelligence application 106, a gateway that proxies requests to the artificial intelligence application 106, or a framework-specific adapter integrated with an artificial intelligence framework executing the artificial intelligence application 106. For example, when the artificial intelligence application 106 implements a multiagent system with coordinator agents, worker agents, and specialized agents, the computing system 102 may intercept all inter-agent communications including task delegation requests, status updates, data transfers, and coordination messages. In an embodiment of the disclosure, the computing system 102 may integrate with multiagent frameworks such as AutoGen by wrapping each agent with security enforcement through a secure_agent function that assigns roles, permissions, and trust levels to each agent, and by creating a secure group chat with enforced communication policies including required signatures, permission enforcement, collusion prevention, and delegation monitoring. The intercepted agent communications form the set of events that are evaluated against the compiled policy representation 110 to detect collusion patterns among the multiple artificial intelligence agents.

At 504, the operations include analyzing the agent communications to detect collusion patterns among the multiple artificial intelligence agents. In an embodiment of the disclosure, the computing system 102 is configured to evaluate the set of events against the compiled policy representation 110 by analyzing the agent communications to detect collusion patterns, and the policy evaluation results include the collusion patterns. The collusion patterns comprise at least one of circular delegation patterns, suspicious information flow patterns, or privilege escalation patterns. The operation at 504 encompasses multiple sub-operations including an operation at 506, an operation at 508, an operation at 510, and an operation at 512, each representing a specific analysis technique applied to the agent communications.

The multi-layered approach to detecting collusion patterns combines graph-based analysis, information flow tracking, and cryptographic verification to identify various types of malicious coordination between artificial intelligence agents that would be undetectable when analyzing individual agent behavior in isolation. In an embodiment of the disclosure, the computing system 102 may apply a detect_agent_collusion function that analyzes agent interactions with configurable parameters including participating agents, a detection threshold, and check patterns specifying the types of collusion to detect such as circular_delegation and hidden_channels. The computing system 102 may also apply an analyze_agent_interaction_patterns function to identify anomalous coordination behaviors across the multiple artificial intelligence agents.

At 506, the operations include constructing an interaction graph representing agent communications between the multiple artificial intelligence agents. In an embodiment of the disclosure, the computing system 102 is configured to construct an interaction graph where nodes represent the multiple artificial intelligence agents and edges represent interactions including messages, tool invocations, and data transfers between the agents. The interaction graph captures the communication topology and relationship patterns among the multiple artificial intelligence agents operating within the artificial intelligence application 106. For example, when the agent module 106c facilitates communication between a coordinator agent, multiple worker agents, and specialized agents, the computing system 102 constructs an interaction graph with nodes for each agent and directed edges representing the direction and type of communications between agents. In an embodiment of the disclosure, the computing system 102 may implement a DetectSuspiciousSubgraphs function that operates on the interaction graph to identify cycles that may indicate circular delegation and clique patterns that may indicate collusion groups. The interaction graph provides the foundation for subsequent graph-based analysis to identify circular delegation patterns and clique patterns that may indicate collusion groups.

At 508, the operations include detecting cycles in the interaction graph based on graph-based analysis to identify circular delegation patterns. In an embodiment of the disclosure, the computing system 102 is configured to apply specialized graph algorithms to detect cycles and suspicious subgraphs within the interaction graph constructed at 506. For each cycle detected in the interaction graph, the computing system 102 determines whether the cycle contains delegation edges representing permission transfers between agents. When a cycle contains delegation edges, the computing system 102 calculates privilege accumulation across the cycle by analyzing the permissions transferred at each edge and computes a suspicion score based on cycle length, privilege accumulation, and edge timing patterns. In an embodiment of the disclosure, the computing system 102 may implement a CalculateCycleSuspicionScore function that takes as inputs the cycle length, privilege accumulation, and edge timing pattern obtained from a GetEdgeTimingPattern function to compute the suspicion score. If the suspicion score exceeds a configured suspicion threshold, the computing system 102 reports the cycle as a suspicious circular delegation pattern through a ReportSuspiciousPattern function. The computing system 102 may also detect clique patterns representing potential collusion groups by finding maximal cliques within the interaction graph using a FindMaximalCliques function with a minimum clique size parameter, and calculating information flow density within each clique using a CalculateInfoFlowDensity function and external information leakage using a CalculateExternalInfoLeakage function to identify suspicious patterns where groups of highly connected agents may be coordinating to bypass security measures. The computing system 102 may further calculate a clique suspicion score using a CalculateCliqueSuspicionScore function based on information flow density, external leakage, clique size, and trust distribution obtained from a GetCliqueTrustDistribution function.

At 510, the operations include analyzing information flow between the multiple artificial intelligence agents based on the agent communications to identify suspicious information flow patterns. In an embodiment of the disclosure, the computing system 102 is configured to build an information flow graph from the intercepted agent communications using a BuildInformationFlowGraph function and track sensitive information propagation between the multiple artificial intelligence agents using a TrackInfoPropagation function. The computing system 102 identifies propagation paths from sensitive data sources and, for each path, checks whether the path violates information flow policies using a ViolatesFlowPolicies function based on the data classification and calculates a flow suspicion score using a CalculateFlowSuspicionScore function based on path length, traversal time, and agent trust levels obtained from a GetAgentTrustLevels function. The computing system 102 may detect information laundering patterns using a DetectInfoLaundering function where information passes through intermediate agents to disguise the source of the information, which may indicate attempts to circumvent information flow controls. For example, when a high-trust agent transfers sensitive information to a low-trust agent through one or more intermediate agents, the computing system 102 may identify the transfer as a suspicious information flow pattern that violates the security policy 112 specifying that information should not flow from higher trust levels to lower trust levels. In an embodiment of the disclosure, the security policy 112 may include a multiagent security policy rule that denies messages where a source agent trust level is greater than a target agent trust level and the content contains sensitive information corresponding to the source agent trust level, thereby controlling information flow between agents with different trust levels.

At 512, the operations include monitoring privilege escalation. In an embodiment of the disclosure, the computing system 102 is configured to monitor privilege escalation by tracking effective permissions of the multiple artificial intelligence agents over time and identifying unauthorized privilege increases. The operation at 512 encompasses sub-operations including an operation at 514 and an operation at 516, which together enable detection of privilege escalation patterns that may indicate collusion or security policy violations. In an embodiment of the disclosure, the security policy 112 may include a rule that denies tool calls where a delegated_from attribute is not null and the delegated_from permissions do not contain the requested tool name, thereby preventing privilege escalation via delegation where an agent attempts to invoke a tool that was not included in the delegated permissions.

At 514, the operations include calculating effective permissions of the multiple artificial intelligence agents based on the agent communications. In an embodiment of the disclosure, the computing system 102 is configured to build privilege timelines for each agent using a BuildPrivilegeTimelines function by tracking permission changes over time based on the intercepted agent communications. The computing system 102 identifies significant privilege increases using a FindSignificantIncreases function by comparing the effective permissions of each agent at different points in time and determines whether each increase is authorized using an IsAuthorizedIncrease function based on the security policy 112 and the delegation records associated with the permission changes. For example, when a worker agent receives delegated permissions from a coordinator agent, the computing system 102 calculates the effective permissions of the worker agent after the delegation and compares the effective permissions against the authorized permission boundaries defined in the security policy 112. In an embodiment of the disclosure, the computing system 102 may apply a check_agent_permissions function to validate that agent permissions conform to the security policy 112 and a validate_agent_delegation function to verify that delegation chains are properly authorized.

At 516, the operations include cryptographically verifying delegation records associated with the calculated effective permissions to identify privilege escalation patterns. In an embodiment of the disclosure, the computing system 102 is configured to cryptographically verify delegation records to ensure that permission transfers between agents are authorized and properly authenticated. Agent identity verification uses cryptographic protocols with selective disclosure credentials and delegation chain verification for multiagent systems. The computing system 102 may implement an agent identity protocol that enables zero-knowledge proofs where agents can prove possession of specific attributes or permissions without revealing entire credential sets, trust level computation based on credential attributes, behavioral history, and contextual factors, contextual authorization based on the specific context of an interaction rather than static permission lists, and delegation chain verification through cryptographic verification of permission delegation chains across multiple agents. In an embodiment of the disclosure, the computing system 102 may implement a VerifyAgentWithSelectiveDisclosure function that generates a challenge nonce, sends a disclosure request to a prover agent specifying requested attributes, minimum trust level, and proof constraints, verifies the disclosure proof against the challenge, validates that the trust level meets minimum requirements using a CalculateTrustLevel function, and evaluates attribute constraints using an EvaluateAttributeConstraints function. For each privilege increase identified at 514, the computing system 102 verifies the cryptographic signatures on the delegation records, validates the delegation chain from the original permission holder to the current agent, and calculates escalation severity using a CalculateEscalationSeverity function based on the difference between before and after privileges. Unauthorized increases exceeding an escalation threshold are reported as privilege escalation patterns of collusion patterns. The cryptographic verification ensures that agents cannot forge delegation records or claim permissions that were not properly delegated through authorized channels. In an embodiment of the disclosure, the security policy 112 may include a rule that denies messages where a verify_agent_identity function returns false, with the verify_agent_identity function configured to check signatures and enforce a maximum token age for agent credentials.

In an embodiment of the disclosure, the agent identity verification may implement selective disclosure capabilities where agents can prove specific attributes without revealing complete credential information. The computing system 102 may generate a challenge nonce and request selective disclosure proof from an agent, specifying requested attributes, minimum trust level requirements, and proof constraints. The agent responds with a disclosure proof that the computing system 102 verifies against the challenge, validates the credential, and evaluates against attribute constraints. The computing system 102 calculates the trust level of the agent based on the disclosed credential and determines whether the trust level meets the minimum requirement specified in the security policy 112. The selective disclosure mechanism enables privacy-preserving authentication where agents reveal only the information necessary for authorization decisions while maintaining cryptographic proof of their identity and permissions. In an embodiment of the disclosure, the computing system 102 may apply a verify_agent_communication function to validate agent-to-agent communications by verifying that the source agent and target agent are properly authenticated and that the content of the communication conforms to the security policy 112.

In an embodiment of the disclosure, the computing system 102 may also perform temporal analysis of agent interactions by implementing an AnalyzeInteractionTiming function that groups interactions by agent pairs, extracts interaction timestamps, calculates regularity scores using a CalculateRegularityScore function, and finds timing correlations across agent pairs using a FindTimingCorrelations function to identify coordinated communications that may indicate collusion. The policy evaluation results generated through the flowchart 500 include the detected collusion patterns, which are used to determine security decisions and cause enforcement of the security decisions on the artificial intelligence application 106 as described in flowchart 200 of FIG. 2.

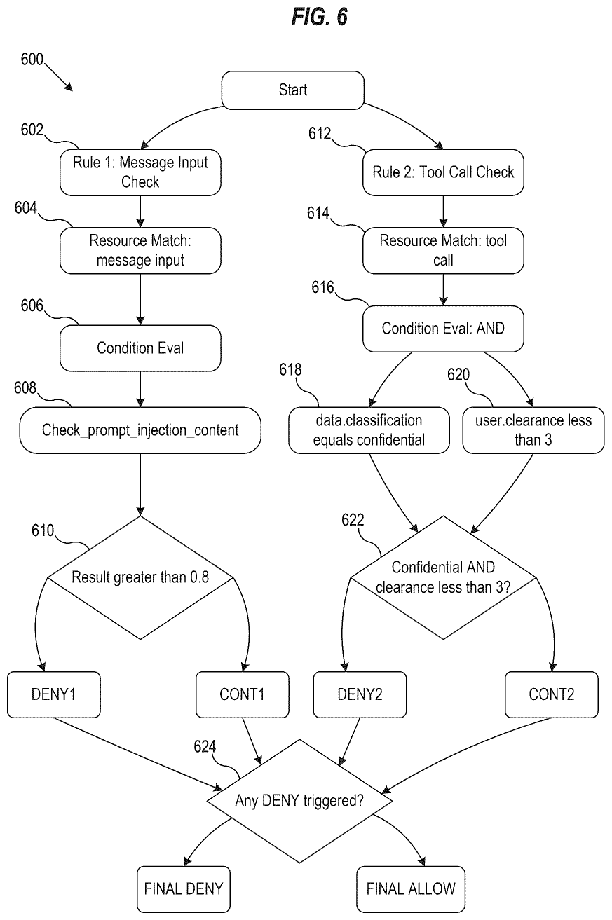

FIG. 6 is a diagram that illustrates an evaluation workflow 600 depicting policy-based security enforcement in artificial intelligence applications, in accordance with an embodiment of the disclosure. FIG. 6 is explained in conjunction with elements from FIG. 1, FIG. 2, FIG. 3, FIG. 4, and FIG. 5. With reference to FIG. 6, there is shown the evaluation workflow 600. The operations of the evaluation workflow 600 may be executed by any computing system, for example, by the computing system 102 of FIG. 1. The evaluation workflow 600 demonstrates a multi-rule evaluation approach using a directed acyclic graph (DAG) structure where different resource types are checked against specific policy conditions, with results combined to determine a final security decision. The evaluation workflow 600 begins at a node 602.

At the node 602, the evaluation workflow 600 starts the policy evaluation process. In an embodiment of the disclosure, the computing system 102 is configured to initiate the evaluation workflow 600 when a set of events is intercepted from the artificial intelligence application 106 during runtime execution on the host system 104. The node 602 represents the entry point for the multi-rule evaluation process where the computing system 102 prepares to evaluate the intercepted events against the compiled policy representation 110. Following the node 602, the evaluation workflow 600 branches into two parallel paths for rule evaluation.

A first path of the evaluation workflow 600 begins at a node 604, which includes Rule 1: Message Input Check. In an embodiment of the disclosure, the computing system 102 is configured to evaluate events against a first rule that targets message input resources. The node 604 initiates the evaluation of a policy rule designed to detect prompt injection attacks in message inputs received by the neural language model 108. The evaluation workflow 600 proceeds from the node 604 to a node 606.

At the node 606, the evaluation workflow 600 includes a resource match operation for message input. In an embodiment of the disclosure, the matching of the set of events comprises indexing policy conditions in the compiled policy representation 110 by the set of resource types, determining a resource type from the set of resource types corresponding to each event in the set of events, and identifying the applicable policy conditions indexed to the determined resource type. The node 606 demonstrates the resource type matching process where the computing system 102 determines whether an intercepted event corresponds to a message input resource type and identifies the applicable policy conditions indexed to the message input resource type. Policy indexing is performed by resource type to enable quick filtering of relevant policies for each request, improving evaluation performance. For example, when the computing system 102 intercepts a user prompt directed to the neural language model 108, the node 606 matches the event to the message input resource type and identifies Rule 1 as an applicable policy condition. The evaluation workflow 600 proceeds from the node 606 to a node 608.

At the node 608, the evaluation workflow 600 includes a condition evaluation operation for the matched rule. In an embodiment of the disclosure, the computing system 102 is configured to evaluate the condition specified in Rule 1 against the intercepted message input event. The node 608 includes application of the security check function associated with the applicable policy condition to generate policy evaluation results. The evaluation workflow 600 proceeds from the node 608 to a node 610.

At the node 610, the evaluation workflow 600 includes a determination of whether the result of a check_prompt_injection function applied to the content is greater than 0.8. In an embodiment of the disclosure, the computing system 102 is configured to compare the output of the prompt injection detection function against a configured threshold value of 0.8. The node 610 represents a threshold comparison that determines whether the message input contains a prompt injection attack with sufficient confidence to trigger a denial. If the result of the check\_prompt\_injection function is greater than 0.8 (Yes branch), the evaluation workflow 600 proceeds to a node 612 labeled DENY1. If the result is not greater than 0.8 (No branch), the evaluation workflow 600 proceeds to a node 614 labeled CONT1.

At the node 612, the evaluation workflow 600 includes generation of a DENY1 result indicating that Rule 1 has detected a violation. In an embodiment of the disclosure, the computing system 102 is configured to record that the message input event violates the prompt injection detection policy condition. The DENY1 result from the node 612 is propagated to subsequent nodes in the DAG for combination with results from other rules.

At the node 614, the evaluation workflow 600 includes generation of a CONT1 result indicating that Rule 1has not detected a violation. In an embodiment of the disclosure, the computing system 102 is configured to record that the message input event passes the prompt injection detection policy condition. The CONT1 result from the node 614 is propagated to subsequent nodes in the DAG for combination with results from other rules.

A second path of the evaluation workflow 600 begins at a node 616, which includes Rule 2: Tool Call Check. In an embodiment of the disclosure, the computing system 102 is configured to evaluate events against a second rule that targets tool call resources. The node 616 initiates the evaluation of a policy rule designed to prevent unauthorized access to confidential data through tool invocations by the tool calling module 106a. The evaluation workflow 600 proceeds from the node 616 to a node 618.

At the node 618, the evaluation workflow 600 includes a resource match operation for tool call. In an embodiment of the disclosure, the computing system 102 is configured to determine whether an intercepted event corresponds to a tool call resource type and identify the applicable policy conditions indexed to the tool call resource type. The node 618 demonstrates the resource type matching process for tool call events, where the computing system 102 identifies Rule 2 as an applicable policy condition when a tool invocation event is intercepted from the tool calling module 106a. The evaluation workflow 600 proceeds from the node 618 to a node 620.

At the node 620, the evaluation workflow 600 includes a condition evaluation operation using an AND operator. In an embodiment of the disclosure, the computing system 102 is configured to evaluate a compound condition that combines multiple sub-conditions using logical AND. The node 620 includes evaluation of two conditions that must both be satisfied for the rule to trigger a denial. The system includes incremental evaluation capabilities that reuse previously computed results for common subexpressions to avoid redundant computation. The node 620 encompasses a node 622 and a node 624, which represent the individual sub-conditions evaluated within the compound condition.

At the node 622, the evaluation workflow 600 includes a determination of whether data. classification equals confidential. In an embodiment of the disclosure, the computing system 102 is configured to evaluate whether the data associated with the tool call event has a classification attribute equal to “confidential”. The node 622 represents a first sub-condition of the compound condition evaluated in the node 620.

At the node 624, the evaluation workflow 600 includes a determination of whether user. clearance is less than 3. In an embodiment of the disclosure, the computing system 102 is configured to evaluate whether the user associated with the tool call event has a clearance level less than 3. The node 624 represents a second sub-condition of the compound condition evaluated in the node 620. The AND operator in the node 620 requires both the node 622 and the node 624 to evaluate to true for the compound condition to be satisfied.

Following the node 620, the evaluation workflow 600 includes a determination of whether both conditions are satisfied (Confidential AND clearance less than 3). If both conditions are satisfied (Yes branch), the evaluation workflow 600 proceeds to a node 626 labeled DENY2. If the conditions are not satisfied (No branch), the evaluation workflow 600 proceeds to a node 628 labeled CONT2. The node 626 includes generation of a DENY2 result indicating that Rule 2has detected a violation where a user with insufficient clearance is attempting to access confidential data through a tool call. The node 628 includes generation of a CONT2 result indicating that Rule 2 has not detected a violation.

Both paths of the evaluation workflow 600 converge at a node 630, which checks whether any DENY has been triggered. In an embodiment of the disclosure, the computing system 102 is configured to combine the results from the first path (DENY1 or CONT1) and the second path (DENY2 or CONT2) to determine the final security decision. The node 630 receives inputs from the node 612, the node 614, the node 626, and the node 628. The convergence at the node 630 demonstrates how the DAG structure enables efficient combination of results from parallel evaluation paths. If any DENY is triggered (Yes branch), the evaluation workflow 600 proceeds to a node 632 labeled FINAL DENY. If no DENY is triggered (No branch), the evaluation workflow 600 proceeds to a node 634 labeled FINAL ALLOW.

At the node 632, the evaluation workflow 600 includes generation of a FINAL DENY security decision. In an embodiment of the disclosure, the causing of the enforcement of the security decision comprises at least one of blocking or allowing execution of operations associated with the set of events based on the security decision, or identifying, from the set of events, a subset of events violating the security policy 112 to generate violation data for the subset of events. When the node 632 includes a FINAL DENY decision, the computing system 102 blocks execution of operations associated with the violating events and generates violation data identifying which rules were violated and the corresponding event data.

At the node 634, the evaluation workflow 600 includes generation of a FINAL ALLOW security decision. In an embodiment of the disclosure, the computing system 102 is configured to allow execution of operations associated with the set of events when no policy violations are detected. The node 634 permits the artificial intelligence application 106 to proceed with processing the intercepted events.

In an embodiment of the disclosure, the evaluation workflow 600 demonstrates how the computing system 102 efficiently processes multiple rules targeting different resource types through DAG-based evaluation with policy indexing and incremental evaluation. The DAG structure enables parallel evaluation of independent policy components, with nodes representing atomic policy conditions and edges representing logical relationships between the conditions. The policy indexing by resource type enables the computing system 102 to quickly identify applicable rules for each intercepted event without evaluating all rules in the compiled policy representation 110. For example, when a message input event is intercepted, the computing system 102 identifies only rules indexed to the message input resource type, such as Rule 1, while when a tool call event is intercepted, the computing system 102 identifies only rules indexed to the tool call resource type, such as Rule 2. The incremental evaluation capabilities enable the computing system 102 to reuse previously computed results for common subexpressions, avoiding redundant computation when multiple rules reference the same attributes or conditions.

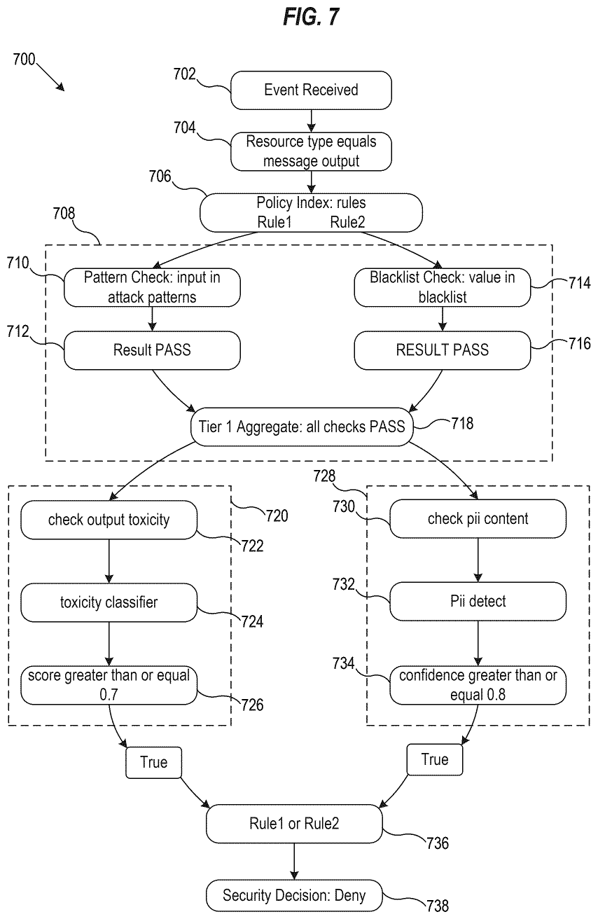

FIG. 7 is a diagram that illustrates an evaluation workflow 700 depicting a tiered evaluation workflow for policy-based security enforcement in artificial intelligence applications, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown the evaluation workflow 700. The operations of the evaluation workflow 700 may be executed by any computing system, for example, by the computing system 102 of FIG. 1.

At the node 702, the evaluation workflow 700 receives an event from an artificial intelligence application. In an embodiment of the disclosure, the computing system 102 is configured to receive a set of events from the artificial intelligence application 106 during runtime execution on the host system 104. The node 702 represents the entry point for the tiered evaluation process where the computing system 102 intercepts events generated by components of the artificial intelligence application 106 including the tool calling module 106a, the RAG module 106b, the agent module 106c, and the neural language model 108. The set of events may comprise retrieval-augmented generation operations generated by the RAG module 106b, and the subset of security check functions may comprise embedding integrity verification functions that detect manipulated embeddings associated with the retrieval-augmented generation operations based on geometric constraints, and source authentication functions that authenticate sources of documents associated with the retrieval-augmented generation operations. The evaluation workflow 700 proceeds from the node 702 to a node 704.

At the node 704, the evaluation workflow 700 includes a determination of whether a resource type equals message output. In an embodiment of the disclosure, the computing system 102 is configured to determine a resource type from the set of resource types corresponding to each event in the set of events. The node 704 demonstrates the resource type matching process where the computing system 102 identifies the resource type of the received event to enable efficient policy indexing. In the example illustrated in FIG. 7, the computing system 102 determines that the resource type equals message output, indicating that the event represents output generated by the neural language model 108. The resource type determination enables the computing system 102 to identify applicable policy conditions indexed to the determined resource type without evaluating all rules in the compiled policy representation 110. The evaluation workflow 700 proceeds from the node 704 to a node 706.

At the node 706, the evaluation workflow 700 includes access to a policy index containing rules. In an embodiment of the disclosure, the computing system 102 is configured to access a policy index that organizes policy conditions by resource type for efficient lookup. The node 706 demonstrates how the computing system 102 retrieves applicable rules from the policy index based on the resource type determined in the node 704. In the example illustrated in FIG. 7, the computing system 102 accesses a policy index containing Rule1 and Rule2that are indexed to the message output resource type. Policies may be organized at multiple hierarchical levels including organization-wide policies that apply across all artificial intelligence applications, application-specific policies tailored to particular use cases, agent-specific policies for individual agents in multiagent systems, method-specific policies for particular function calls, and just-in-time temporary policies for specific scenarios or time-limited access grants. The hierarchical policy organization enables the computing system 102 to apply different security policies based on the organizational context, application context, agent context, or method context of the received event. The evaluation workflow 700 proceeds from the node 706 to a node 708.

At the node 708, the evaluation workflow 700 includes Tier 1 evaluation comprising lightweight security checks. In an embodiment of the disclosure, the computing system 102 is configured to apply a first tier of security check functions based on at least one of pattern matching, hash lookups, or bloom filters. The node 708 encompasses two parallel evaluation paths within the DAG structure for rapid filtering of events using computationally inexpensive checks. The node 708 includes a node 710 and a node 714, which represent individual Tier 1 checks that execute in parallel to enable fail-fast evaluation. The Tier 1 evaluation prioritizes deterministic rules over machine learning models to enable rapid detection of violations without requiring computationally intensive analysis.

At the node 710, the evaluation workflow 700 includes a pattern check operation that compares input against attack patterns. In an embodiment of the disclosure, the computing system 102 is configured to apply pattern matching to detect known attack signatures in the message output event. The node 710 demonstrates how the computing system 102 compares the content of the received event against a set of predefined attack patterns using regex matching or string comparison operations. The pattern check in the node 710 enables rapid detection of known attack signatures without requiring machine learning model inference. The evaluation workflow 700 proceeds from the node 710 to a node 712.

At the node 712, the evaluation workflow 700 includes a result of PASS for the pattern check. In an embodiment of the disclosure, the computing system 102 is configured to record that the pattern check in the node 710 did not detect any known attack patterns in the message output event. The node 712 represents a passing result from the pattern check that enables the evaluation workflow 700 to continue to subsequent checks within the DAG structure. The computing system 102 may implement expression caching to store the result of the pattern check for reuse if the same or similar content is evaluated in subsequent events, avoiding redundant computation.

At the node 714, the evaluation workflow 700 includes a blacklist check operation to determine whether a value is present in a blacklist. In an embodiment of the disclosure, the computing system 102 is configured to perform hash lookups against a blacklist of prohibited values, domains, or identifiers. The node 714 demonstrates how the computing system 102 uses hash-based comparisons to rapidly determine whether the message output event contains blacklisted content. The blacklist check in the node 714 executes in parallel with the pattern check in the node 710 within the DAG structure, enabling concurrent evaluation of multiple Tier 1 checks. The evaluation workflow 700 proceeds from the node 714 to a node 716.

At the node 716, the evaluation workflow 700 includes a result of PASS for the blacklist check. In an embodiment of the disclosure, the computing system 102 is configured to record that the blacklist check in the node 714 did not detect any blacklisted content in the message output event. The node 716 represents a passing result from the blacklist check that enables the evaluation workflow 700 to continue to subsequent checks. The computing system 102 may implement function result memoization to store the result of the blacklist check for reuse when the same function is called with the same arguments in subsequent evaluations.

At a node 718, the evaluation workflow 700 includes a Tier 1 aggregate operation that determines that all checks have passed. In an embodiment of the disclosure, the computing system 102 is configured to aggregate the results from the node 712 and the node 716 to determine whether the Tier 1 evaluation has detected any violations. The node 718 includes combination of the results from the parallel Tier 1 checks using logical operations specified in the compiled policy representation 110. In the example illustrated in FIG. 7, the computing system 102 determines that all Tier 1 checks have passed, indicating that the message output event does not contain known attack patterns or blacklisted content. When all Tier 1 checks pass, the evaluation workflow 700 proceeds to Tier 2 evaluation for more detailed analysis. The evaluation workflow 700 proceeds from the node 718 to a node 728.

At the node 728, the evaluation workflow 700 includes Tier 2 evaluation comprising more detailed analysis. In an embodiment of the disclosure, the computing system 102 is configured to apply a second tier of security check functions when the Tier 1 results indicate that additional evaluation is warranted. The node 728 encompasses two parallel evaluation paths within the DAG structure for machine learning-based analysis of the message output event. The node 728 includes a node 720 and a node 730, which represent individual Tier 2 checks that apply machine learning models for specific security tasks. The Tier 2 evaluation combines deterministic rules with machine learning models trained for specific security tasks such as toxicity classification and personally identifiable information detection.

At the node 720, the evaluation workflow 700 includes an output toxicity check. In an embodiment of the disclosure, the computing system 102 is configured to initiate toxicity analysis of the message output event. The node 720 represents the beginning of a toxicity detection path within the DAG that applies machine learning-based classification to identify harmful content in the output generated by the neural language model 108. The evaluation workflow 700 proceeds from the node 720 to a node 722.

At the node 722, the evaluation workflow 700 includes application of a toxicity classifier to the content. In an embodiment of the disclosure, the computing system 102 is configured to apply a specialized machine learning model trained for toxicity classification to the message output event. The node 722 demonstrates how the computing system 102 uses a lightweight classifier model rather than a large language model to generate a toxicity score for the content. The toxicity classifier in the node 722 may be trained to detect multiple categories of harmful content including hate speech, violence, self-harm, and other toxic content types. The computing system 102 may implement function result memoization to store the toxicity classification result for reuse when the same content is evaluated in subsequent events. The evaluation workflow 700 proceeds from the node 722 to a node 724.

At the node 724, the evaluation workflow 700 includes a determination of whether a toxicity score is greater than or equal to 0.7. In an embodiment of the disclosure, the computing system 102 is configured to compare the toxicity score generated by the toxicity classifier in the node 722 against a configured threshold value of 0.7. The node 724 represents a threshold comparison that determines whether the message output event contains toxic content with sufficient confidence to trigger a violation. If the toxicity score is greater than or equal to 0.7 (Yes branch), the evaluation workflow 700 proceeds to a node 726. If the toxicity score is less than 0.7 (No branch), the toxicity check path does not trigger a violation.

At the node 726, the evaluation workflow 700 includes recording of a toxicity violation. In an embodiment of the disclosure, the computing system 102 is configured to record that the toxicity check has detected a violation where the message output event contains toxic content exceeding the configured threshold. The node 726 represents a violation result from the toxicity detection path that is propagated to subsequent nodes in the DAG for combination with results from other checks.

At the node 730, the evaluation workflow 700 includes a PII content check. In an embodiment of the disclosure, the computing system 102 is configured to initiate personally identifiable information detection analysis of the message output event. The node 730 represents the beginning of a PII detection path within the DAG that applies machine learning-based entity recognition to identify sensitive personal information in the output generated by the neural language model 108. The evaluation workflow 700 proceeds from the node 730 to a node 732.

At the node 732, the evaluation workflow 700 includes PII detection on the content. In an embodiment of the disclosure, the computing system 102 is configured to apply a specialized machine learning model trained for personally identifiable information detection to the message output event. The node 732 demonstrates how the computing system 102 uses entity recognition techniques to identify PII types including social security numbers, credit card numbers, addresses, email addresses, and phone numbers. The PII detection in the node 732 generates a confidence score indicating the likelihood that the detected entities represent actual personally identifiable information. The computing system 102 may implement expression caching to store intermediate results from the PII detection for reuse in subsequent evaluations. The evaluation workflow 700 proceeds from the node 732 to a node 734.

At the node 734, the evaluation workflow 700 includes a determination of whether a confidence level is greater than or equal to 0.8. In an embodiment of the disclosure, the computing system 102 is configured to compare the confidence score generated by the PII detection in the node 732 against a configured threshold value of 0.8. The node 734 represents a threshold comparison that determines whether the message output event contains personally identifiable information with sufficient confidence to trigger a violation. If the confidence level is greater than or equal to 0.8 (Yes branch), the PII detection path triggers a violation. If the confidence level is less than 0.8 (No branch), the PII detection path does not trigger a violation.

At a node 736, the evaluation workflow 700 includes an evaluation of whether Rule1or Rule2 has been triggered based on the results from the node 726 and the node 734. In an embodiment of the disclosure, the computing system 102 is configured to combine the results from the toxicity detection path and the PII detection path to determine whether any rules have been triggered. The node 736 receives inputs from the node 726 indicating a toxicity violation and from the node 734 indicating whether a PII violation has been detected. The node 736 demonstrates how the computing system 102 aggregates results from multiple Tier 2 checks within the DAG structure to determine the overall policy evaluation result. In the example illustrated in FIG. 7, the computing system 102 determines that at least one rule has been triggered based on the toxicity violation detected in the node 726. The evaluation workflow 700 proceeds from the node 736 to a node 738.

At the node 738, the evaluation workflow 700 includes generation of a security decision to deny the operation. In an embodiment of the disclosure, the computing system 102 is configured to determine a security decision based on the policy evaluation results and cause enforcement of the security decision on the artificial intelligence application 106. The node 738 represents the final security decision where the computing system 102 denies the message output event based on the toxicity violation detected during Tier 2 evaluation. The causing of the enforcement of the security decision may comprise blocking execution of operations associated with the set of events based on the security decision, or identifying, from the set of events, a subset of events violating the security policy 112 to generate violation data for the subset of events. The computing system 102 may generate violation data including the violation type, the policy rule violated, the input and output data, and timestamp and context information for forensic analysis and compliance reporting.

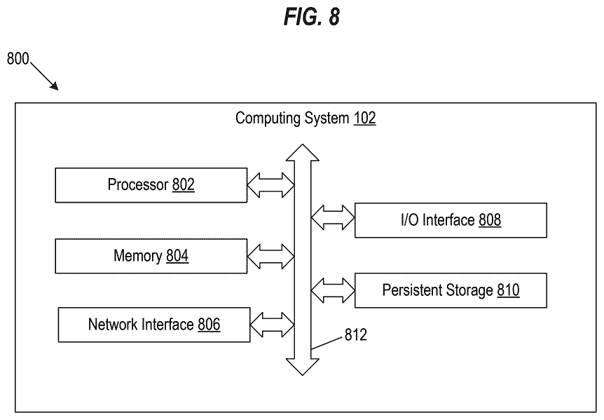

FIG. 8 is a diagram that illustrates a block diagram 800 of the computing system 102 for implementing policy-based security enforcement in artificial intelligence applications, in accordance with an embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, there is shown the block diagram 800 of the computing system 102 that includes a processor 802, a memory 804, a network interface 806, an input/output (I/O) interface 808, and a persistent storage 810, all interconnected through a bus 812. The computing system 102 may be configured to support the compiled policy representation 110, the security policy 112, and the policy-based security enforcement operations described in the flowchart 200, the flowchart 300, the flowchart 400, the flowchart 500, the evaluation workflow 600, and the evaluation workflow 700.

The processor 802 may include suitable logic, circuitry, and interfaces that may be configured to execute program instructions associated with policy-based security enforcement operations to be executed by the computing system 102. The processor 802 may include any suitable special-purpose or general-purpose computer, computing entity, or processing device including various computer hardware or software modules and may be configured to execute instructions stored on any applicable computer-readable storage media. For example, the processor 802 may include a microprocessor, a microcontroller, a digital signal processor (DSP), an application-specific integrated circuit (ASIC), a Field-Programmable Gate Array (FPGA), or any other digital or analog circuitry configured to interpret and execute program instructions and process data. Although illustrated as a single processor in FIG. 8, the processor 802 may include any number of processors configured to, individually or collectively, perform or direct performance of any number of operations of the computing system 102, as described in the present disclosure. Some of the examples of the processor 802 may be a GPU, a CPU, a RISC processor, an ASIC processor, a CISC processor, a co-processor, and a combination thereof.

The processor 802 may be configured to access a compiled policy representation of a security policy associated with an artificial intelligence application, wherein the security policy is written in a domain-specific policy grammar, and the security policy specifies a set of resource types corresponding to components of the artificial intelligence application, and a set of security check functions associated with the set of resource types. The processor 802 may be configured to intercept a set of events associated with the artificial intelligence application during a runtime execution of the artificial intelligence application on a host system. The processor 802 may be configured to evaluate the set of events against the compiled policy representation by matching the set of events to at least one resource type of the set of resource types to identify applicable policy conditions in the compiled policy representation, and applying a subset of security check functions to the set of events to generate policy evaluation results, wherein the set of security check functions includes the subset of security check functions associated with the applicable policy conditions. The processor 802 may be configured to determine a security decision based on the policy evaluation results and cause enforcement of the security decision on the artificial intelligence application.

The processor 802 may implement multi-core processing capabilities that enable parallel execution of security check functions through the compiled policy representation 110 and traversal processes through the directed acyclic graph structure, supporting efficient resource utilization during policy evaluation operations. The processor 802 may support specialized instruction sets for policy evaluation operations including pattern matching, hash lookups, bloom filter operations, and machine learning model inference that enable efficient execution of tiered security check functions. The processor 802 may be configured to execute policy compilation operations comprising parsing the security policy 112 into an abstract syntax tree, converting the abstract syntax tree into an intermediate representation, and applying optimization passes including constant folding operations, dead code elimination, semantic policy factorization, and common subexpression elimination to generate the compiled policy representation 110 as a directed acyclic graph structure.

The processor 802 may be configured to execute just-in-time (JIT) compilation for performance-critical policies to generate optimized machine code for maximum execution speed. The JIT compilation enables the processor 802 to transform policy conditions and security check functions into native machine instructions that execute with minimal overhead compared to interpreted evaluation approaches. For example, when a policy condition specifies a pattern matching operation against message content, the JIT compilation may generate optimized machine code that performs the pattern matching directly without interpreter overhead, achieving speedup for critical evaluation paths. The processor 802 may implement specialized natural language processing capabilities that enable the neural language model 108 to translate natural language policy descriptions into the domain-specific policy grammar, supporting policy creation by security personnel without requiring coding expertise.

In some embodiments, the processor 802 may be configured to interpret and execute program instructions and process data stored in the memory 804 and the persistent storage 810. In some embodiments, the processor 802 may fetch program instructions from the persistent storage 810 and load the program instructions in the memory 804. After the program instructions are loaded into the memory 804, the processor 802 may execute the program instructions. The processor 802 may be configured to execute the security check functions including prompt injection detection functions, output validation functions, agent identity verification functions, embedding tampering detection functions, source authentication functions, data leakage detection functions, personally identifiable information detection functions, encryption validation functions, signature verification functions, and collusion detection functions while maintaining deterministic security decisions based on the policy evaluation results.

The memory 804 may include suitable logic, circuitry, and interfaces that may be configured to store program instructions executable by the processor 802. The memory 804 may be configured to store program instructions, data structures, and intermediate results for policy-based security enforcement operations, including compiled policy representations, security check function results, policy evaluation results, and security decisions. The memory 804 may include computer-readable storage media for carrying or having computer-executable instructions or data structures stored thereon. Such computer-readable storage media may include any available media that may be accessed by a general-purpose or special-purpose computer, such as the processor 802. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices, or any other storage medium which may be used to carry or store particular program code in the form of computer-executable instructions or data structures and which may be accessed by a general-purpose or special-purpose computer.

The memory 804 may implement specialized data structures for efficient policy representation including directed acyclic graph structures with nodes representing atomic policy conditions and edges representing logical relationships between the atomic policy conditions, enabling cross-component optimization and parallel evaluation of independent policy components. The memory 804 may maintain temporary storage for expression caching where results of common subexpressions are cached to avoid redundant evaluation, and function result memoization where results of deterministic security check functions are memoized to avoid recomputation when the same function is called with the same arguments. The memory 804 may store policy indexes organized by resource type that enable rapid identification of applicable rules when events are received, supporting efficient policy enforcement by avoiding unnecessary evaluation of rules that do not apply to the current event type.

The memory 804 may store locally cached compiled policy representations retrieved from a remote policy server, enabling the computing system 102 to enforce security policies without requiring network communication for each policy evaluation operation. The memory 804 may support dynamic policy updates without requiring code changes or application restarts, where updated policies received from a Command Center interface through the network interface 806 are loaded into the memory 804 and take effect immediately for subsequent policy evaluation operations. The dynamic policy update capability enables real-time policy modifications through the Command Center, allowing security teams to adapt to emerging threats and changing organizational requirements without disrupting the runtime execution of the artificial intelligence application 106.

The network interface 806 may include suitable logic, circuitry, interfaces, and code that may be configured to establish communication between the computing system 102, the host system 104, the external system 114, and the user device 120. The network interface 806 may enable communication with external systems through various protocols and connection types, supporting reception of events from the artificial intelligence application 106 and transmission of security decisions through secure communication channels. The network interface 806 may be implemented by use of various known technologies to support wired or wireless communication of the computing system 102. The network interface 806 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and a local buffer.

The network interface 806 may communicate via wireless communication with networks, such as the Internet, an Intranet, and a wireless network, such as a cellular telephone network, a wireless local area network (LAN) and a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi), voice over Internet Protocol (VoIP), light fidelity (Li-Fi), or Wi-MAX. The network interface 806 may facilitate real-time policy enforcement operations and reception of policy updates from the Command Center interface for dynamic security policy management. The network interface 806 may implement secure communication protocols that protect sensitive policy data and violation information during transmission while enabling comprehensive policy enforcement capabilities across different deployment environments.

The network interface 806 may support communication with a telemetry server that stores complete audit trails of all inputs, outputs, and violation contexts for forensic analysis and compliance reporting. After violation detection, the network interface 806 may transmit violation data including the violation type, the policy rule violated, the input and output data, and timestamp and context information to the telemetry server for storage and subsequent analysis. The telemetry server integration enables the computing system 102 to maintain comprehensive records of security events across different artificial intelligence applications and policy configurations, supporting incident response workflows and regulatory compliance requirements.

The I/O interface 808 may include suitable logic, circuitry, interfaces, and code that may be configured to receive inputs and provide outputs for policy-based security enforcement operations. The I/O interface 808 may include various input and output devices, which may be configured to communicate with the processor 802 and other components, such as the network interface 806. Examples of the input devices may include, but are not limited to, a touch screen, a keyboard, a mouse, a joystick, and a microphone. Examples of the output devices may include, but are not limited to, a display and a speaker. The I/O interface 808 may provide connectivity to the user device 120 and support interaction with the user interface 122 for configuration of security policy parameters and presentation of policy evaluation results.

The I/O interface 808 may enable the user 128 to specify natural language policy descriptions through the input 124 and receive feedback through the user interface 122 regarding policy generation, security policy implementation, and system status. The I/O interface 808 may support dashboard and visualization capabilities for security event presentation, administrative interfaces for policy management, and real-time monitoring capabilities for continuous policy enforcement operations in production environments. The I/O interface 808 may enable security decisions that include additional actions beyond allow and deny, such as block and unblock operations for persistent entity blocking, user-in-the-loop escalation where security decisions are routed to human operators for review, and integration with existing security incident response workflows through escalation playbooks that connect to security information and event management systems, messaging platforms, and security analyst tools.

The persistent storage 810 may include suitable logic, circuitry, and interfaces that may be configured to store program instructions executable by the processor 802, operating systems, and application-specific information, such as logs, security policies, and compiled policy representations. The persistent storage 810 may include computer-readable storage media for carrying or having computer-executable instructions or data structures stored thereon. Such computer-readable storage media may include any available media that may be accessed by a general-purpose or special-purpose computer, such as the processor 802. By way of example, and not limitation, such computer-readable storage media may include tangible or non-transitory computer-readable storage media including Compact Disc Read-Only Memory (CD-ROM) or other optical disk storage, magnetic disk storage or other magnetic storage devices, flash memory devices, or any other storage medium which may be used to carry or store particular program code in the form of computer-executable instructions or data structures and which may be accessed by a general-purpose or special-purpose computer.

The persistent storage 810 may provide long-term storage for security policies written in the domain-specific policy grammar, compiled policy representations, policy indexes, machine learning models for security check functions, and configuration data for policy enforcement operations. The persistent storage 810 may maintain comprehensive records of policy versions, policy update history, and policy configuration changes across different artificial intelligence applications and organizational contexts. The persistent storage 810 may store specialized machine learning models including toxicity classifiers, personally identifiable information detection models, prompt injection detection models, and embedding tampering detection models that are loaded into the memory 804 during policy evaluation operations. The persistent storage 810 may implement automated backup and recovery mechanisms that ensure continuity of policy enforcement operations and preservation of security policy data for audit and compliance purposes.

The persistent storage 810 may store program instructions for WebAssembly-based integration that enables cross-platform deployment of policy enforcement capabilities across different environments including browsers, server-side applications, and edge computing platforms. The WebAssembly-based integration enables the computing system 102 to execute policy evaluation operations in sandboxed environments with near-native performance, supporting deployment scenarios where traditional native code execution is not available or where cross-platform compatibility is required. The WebAssembly modules may include compiled policy representations, security check functions, and policy evaluation logic that execute consistently across different runtime environments while maintaining the deterministic security decision behavior specified in the security policy 112.

The bus 812 may provide communication pathways between all components of the computing system 102. The bus 812 may support parallel processing architectures that enable simultaneous execution of security check functions, directed acyclic graph traversal processes, policy evaluation operations, and machine learning model inference procedures. The bus 812 may implement specialized communication protocols optimized for policy enforcement workloads, including efficient transfer of event data, policy evaluation results, and security decisions between the processor 802, the memory 804, and other system components. The bus 812 may enable real-time coordination between components of the computing system 102 during tiered policy evaluation operations where lightweight first tier checks, directed acyclic graph traversal second tier checks, and machine learning-based third tier checks execute in sequence or in parallel based on the policy configuration and evaluation results.

Modifications, additions, or omissions may be made to the computer system 102 without departing from the scope of the present disclosure. For example, in some embodiments, the computer system 102 may include any number of other components that may not be explicitly illustrated or described.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
accessing a compiled policy representation of a security policy associated with an artificial intelligence application, wherein
the security policy is written in a domain-specific policy grammar, and
the security policy specifies:
a set of resource types corresponding to components of the artificial intelligence application, and
a set of security check functions associated with the set of resource types;
intercepting a set of events associated with the artificial intelligence application during a runtime execution of the artificial intelligence application on a host system;
evaluating the set of events against the compiled policy representation by:
matching the set of events to at least one resource type of the set of resource types to identify applicable policy conditions in the compiled policy representation, wherein the set of security check functions includes a subset of security check functions associated with the applicable policy conditions, and
applying the subset of security check functions to the set of events to generate policy evaluation results;
determining a security decision based on the policy evaluation results; and
causing enforcement of the security decision on the artificial intelligence application.

2. The computer-implemented method according to claim 1, wherein the set of resource types comprises at least one of message resources, tool resources, agent resources, retrieval-augmented generation resources, prompt resources, response resources, model resources, embedding resources, key resources, or trace resources.

3. The computer-implemented method according to claim 1, wherein the set of security check functions associated with the set of resource types comprises at least one of prompt injection detection functions, output validation functions, agent identity verification functions, embedding tampering detection functions, source authentication functions, data leakage detection functions, personally identifiable information detection functions, encryption validation functions, signature verification functions, or collusion detection functions.

4. The computer-implemented method according to claim 1, wherein the set of security check functions incorporates deterministic rules including at least one of regex patterns, blacklists, whitelists, or threshold comparisons.

5. The computer-implemented method according to claim 1, wherein the compiled policy representation comprises a directed acyclic graph structure having nodes representing atomic policy conditions of the security policy and edges representing logical relationships between the atomic policy conditions.

6. The computer-implemented method according to claim 1, further comprising compiling the security policy into the compiled policy representation by:
parsing the security policy into an abstract syntax tree;
converting the abstract syntax tree into an intermediate representation; and
applying optimization passes to the intermediate representation to generate a directed acyclic graph structure as the compiled policy representation,
wherein the optimization passes include at least one of a constant folding operation, dead code elimination, semantic policy factorization, or common subexpression elimination.

7. The computer-implemented method according to claim 6, wherein the applying of the semantic policy factorization comprises:
converting the security policy to disjunctive normal form;
extracting terms from the disjunctive normal form;
building a term dependency graph based on the extracted terms;
identifying independent subgraphs in the term dependency graph; and
identifying parallelizable components in the intermediate representation based on the independent subgraphs.

8. The computer-implemented method according to claim 7, wherein the parallelizable components identified in the intermediate representation are represented as parallelizable nodes in the directed acyclic graph structure, and wherein the evaluating of the set of events comprises parallel evaluation of the parallelizable nodes against the set of events.

9. The computer-implemented method according to claim 1, wherein the intercepting of the set of events comprises using at least one of:
a function wrapper applicable to a function of the artificial intelligence application;
a gateway that proxies requests to the artificial intelligence application; or
a framework-specific adapter integrated with an artificial intelligence framework executing the artificial intelligence application.

10. The computer-implemented method according to claim 1, wherein the matching of the set of events comprises:
indexing policy conditions in the compiled policy representation by the set of resource types;
determining a resource type from the set of resource types corresponding to each event in the set of events; and
identifying the applicable policy conditions indexed to the determined resource type.

11. The computer-implemented method according to claim 1, wherein the applying of the subset of security check functions comprises:
applying a first tier of security check functions of the subset of security check functions based on at least one of pattern matching, hash lookups, or bloom filters;
applying, based on results of the first tier of security check functions, a second tier of security check functions of the subset of security check functions to traverse the compiled policy representation; and
applying, based on results of the second tier of security check functions, a third tier of security check functions of the subset of security check functions, wherein the third tier of security check functions uses machine learning models.

12. The computer-implemented method according to claim 1, wherein the set of events comprises agent communications between multiple artificial intelligence agents of the artificial intelligence application, and wherein the evaluating of the set of events against the compiled policy representation comprises analyzing the agent communications to detect collusion patterns among the multiple artificial intelligence agents, and the policy evaluation results include the collusion patterns.

13. The computer-implemented method according to claim 12, wherein the collusion patterns comprise at least one of circular delegation patterns, suspicious information flow patterns, or privilege escalation patterns, and wherein the analyzing of the agent communications to detect the collusion patterns comprises:
constructing an interaction graph representing the agent communications between the multiple artificial intelligence agents;
detecting cycles in the interaction graph based on graph-based analysis to identify the circular delegation patterns;
analyzing information flow between the multiple artificial intelligence agents based on the agent communications to identify the suspicious information flow patterns; and
monitoring privilege escalation by:
calculating effective permissions of the multiple artificial intelligence agents based on the agent communications; and
cryptographically verifying delegation records associated with the calculated effective permissions to identify the privilege escalation patterns.

14. The computer-implemented method according to claim 1, wherein the set of events comprises retrieval-augmented generation operations, and the subset of security check functions comprises:
embedding integrity verification functions that detect manipulated embeddings associated with the retrieval-augmented generation operations based on geometric constraints; and
source authentication functions that authenticate sources of documents associated with the retrieval-augmented generation operations.

15. The computer-implemented method according to claim 1, wherein the causing of the enforcement of the security decision comprises at least one of:
blocking or allowing execution of operations associated with the set of events based on the security decision; or
identifying, from the set of events, a subset of events violating the security policy; and
generating, based on the identifying, violation data for the subset of events.

16. The computer-implemented method according to claim 1, wherein the accessing of the compiled policy representation comprises retrieving the compiled policy representation from at least one of a local cache or a remote policy server.

17. The computer-implemented method according to claim 1, wherein
the domain-specific policy grammar defines syntax for expressing a plurality of security policies specific to a plurality of artificial intelligence applications using a context-free grammar,
the plurality of security policies includes the security policy associated with the artificial intelligence application, and
the plurality of artificial intelligence applications includes the artificial intelligence application.

18. The computer-implemented method according to claim 1, further comprising translating a natural language policy description into the security policy based on a neural language model.

19. A computing system, comprising:
a processor configured to:
access a compiled policy representation of a security policy associated with an artificial intelligence application, wherein
the security policy is written in a domain-specific policy grammar, and
the security policy specifies:
a set of resource types corresponding to components of the artificial intelligence application, and
a set of security check functions associated with the set of resource types;
intercept a set of events associated with the artificial intelligence application during a runtime execution of the artificial intelligence application on a host system;
evaluate the set of events against the compiled policy representation by:
match of the set of events to at least one resource type of the set of resource types to identify applicable policy conditions in the compiled policy representation, wherein the set of security check functions includes a subset of security check functions associated with the applicable policy conditions, and
application of the subset of security check functions to the set of events to generate policy evaluation results;
determine a security decision based on the policy evaluation results; and
cause enforcement of the security decision on the artificial intelligence application.

20. A computer-program product, comprising:
one or more computer-readable storage media; and
program instructions stored on the one or more computer-readable storage media to perform operations comprising:
accessing a compiled policy representation of a security policy associated with an artificial intelligence application, wherein
the security policy is written in a domain-specific policy grammar, and
the security policy specifies:
a set of resource types corresponding to components of the artificial intelligence application, and
a set of security check functions associated with the set of resource types;
intercepting a set of events associated with the artificial intelligence application during a runtime execution of the artificial intelligence application on a host system;
evaluating the set of events against the compiled policy representation by:
matching the set of events to at least one resource type of the set of resource types to identify applicable policy conditions in the compiled policy representation, wherein the set of security check functions includes a subset of security check functions associated with the applicable policy conditions,
applying the subset of security check functions to the set of events to generate policy evaluation results;
determining a security decision based on the policy evaluation results; and
causing enforcement of the security decision on the artificial intelligence application.
